(19) United States
(12) Patent Application Publication
(10) Pub. No.: US 2022/0278378 A1
(43) Pub. Date: Sep. 1, 2022

(54) ACOUSTIC WAVE DRIVEN MIXING FOR SUPPRESSION OF DENDRITE FORMATION AND ION DEPLETION IN BATTERIES

(71) Applicants: The Regents of the University of California, Oakland, CA (US); Technion Research & Development Foundation Ltd., Haifa (IL)

(72) Inventors: James Friend, San Diego, CA (US); An Huang, San Diego, CA (US); Ping Liu, San Diego, CA (US); Haodong Liu, San Diego, CA (US); Ofer Manor, Haifa (IL); Viswanathan Krishnan, San Diego, CA (US)

(21) Appl. No.: 17/632,036

(22) PCT Filed: Aug. 1, 2020
(86) PCT No.: PCT/US20/44685

§ 371 Date: Feb. 1, 2022

Related U.S. Application Data
(60) Provisional application No. 62/882,450, filed on Aug. 2, 2019.
(60) Provisional application No. 62/968,556, filed on Jan. 31, 2020.

(51) Int. Cl. H01M 10/42; H01M 10/44; B01F 31/80

(52) U.S. Cl. CPC H01M 10/4214; H01M 10/44; H01M 10/425; B01F 31/80; B01F 2101/59

(57) ABSTRACT

A battery may include a first electrode, a second electrode, an electrolyte, and at least one acoustic device configured to generate acoustic streaming during a charging and/or a discharging of the battery. The charging of the battery may trigger cations from the first electrode to travel through the electrolyte and deposit on the second electrode while the discharging of the battery may trigger cations from the second electrode to travel through the electrolyte and deposit on the first electrode. The acoustic streaming may drive a mixing and/or a turbulent flow of the electrolyte, which may increase a charge rate and/or a discharge rate of the battery by increasing diffusion rate of cations and/or anions. The mixing and/or the turbulent flow may further prevent a formation of dendrites on the first electrode and/or the second electrode by at least homogenizing a distribution of the cations and/or anions in the electrolyte.

### RELATED APPLICATION

This application claims priority to U.S. Provisional Patent Application No. 62/882,450, filed on Aug. 2, 2019 and entitled “CHEMISTRY-AGNOSTIC PREVENTION OF ION DEPLETION AND DENDRITE FORMATION IN A LIQUID ELECTROLYTE,” and U.S. Provisional Application No. 62/968,556, filed on Jan. 31, 2020 and entitled “CHEMISTRY-AGNOSTIC PREVENTION OF ION DEPLETION AND DENDRITE FORMATION IN A LIQUID ELECTROLYTE,” the disclosures of which are incorporated herein by reference in their entirety.

### STATEMENT OF GOVERNMENT SPONSORED SUPPORT

This invention was made with government support under Grant Number EE008363 awarded by the Department of Energy. The government has certain rights in the invention.

### TECHNICAL FIELD

The subject matter disclosed herein relates generally to battery technology and more specifically to the suppression of dendrite formation and ion depletion in rechargeable batteries.

### BACKGROUND

A battery may convert, through oxidation and reduction, chemical energy into electrical energy, and vice versa. For example, during the discharge of the battery, atoms at an anode (e.g., negative electrode) of the battery may oxidize to form cations (e.g., positively charged ions) and free electrons. The free electrons may migrate from the anode to a cathode (e.g., positive electrode) of the battery, thereby generating an electric current through an external circuit that includes an electric load of the battery. Moreover, the cations may also travel to the cathode through an electrolyte interposed between the anode and the cathode. Meanwhile, to charge the battery, an electric current may be applied to the battery to cause the atoms at the cathode to oxidize and form both cations and free electrons. The free electrons may return to the anode through the external circuit while the cations may travel through the electrolyte in order to return to the anode.

### SUMMARY

Articles of manufacture and methods associated with batteries resistant to dendrite formation and ion depletion are provided. In one aspect, there is provided a battery that includes: a first electrode; a second electrode; an electrolyte interposed between the first electrode and the second electrode; and at least one acoustic device configured to generate acoustic streaming during a charging and/or a discharging of the battery, the charging of the battery triggering cations from the first electrode to travel through the electrolyte and deposit on the second electrode, the discharging of the battery triggering cations from the second electrode to travel through the electrolyte and deposit on the first electrode, the acoustic streaming driving a mixing and/or a turbulent flow of the electrolyte, the mixing and/or the turbulent flow of the electrolyte increasing a charge rate and/or a discharge rate of the battery by at least increasing a diffusion rate of cations and/or anions, and the mixing and/or the turbulent flow further preventing a formation of dendrites on the first electrode and/or the second electrode by at least homogenizing a distribution of the cations and/or anions in the electrolyte.

In some variations, one or more features disclosed herein including the following features can optionally be included in any feasible combination. The homogenization may prevent the formation of dendrites by at least decreasing a concentration gradient of the cations and/or anions in the electrolyte.

In some variations, the homogenization may prevent the formation of dendrites by at least increasing a uniformity of the distribution of the cations and anions in the electrolyte.

In some variations, the homogenization may prevent the formation of dendrites by at least increasing a uniformity of the deposit of cations on the first electrode and/or the second electrode.

In some variations, the mixing flow of the electrolyte may further maximize a transport of cations and/or anions to replace the cations and/or anions depleted from the electrolyte during the charging and/or the discharging of the battery.

In some variations, the electrolyte may comprise a liquid electrolyte including one or more of a water, a carbonate-based electrolyte, an ester-based electrolyte, an ether-based electrolyte, an ionic liquid, a nitrile based electrolyte, a phosphate based electrolyte, a sulfur-based electrolyte, and a sulfone-based electrolyte.

In some variations, the electrolyte may comprise a polymer-based electrolyte, an organic electrolyte, a solid electrolyte, a non-aqueous organic solvent electrolyte, and a gas electrolyte.

In some variations, the first electrode may be an anode of the battery.

In some variations, the anode of the battery may be formed from a metal including at least one of a lithium (Li), potassium (K), magnesium (Mg), copper (Cu), zinc (Zn), sodium (Na), and lead (Pb)).

In some variations, the anode of the battery may be formed from an intercalated material including at least one of a graphite, graphene, and/or titanium dioxide (TiO2)).

In some variations, the anode of the battery may be formed from an alloy including at least one of a silicon (Si), aluminum (Al), and tin (Sn).

In some variations, the anode of the battery may be formed from a conversion material including a copper peroxide (CuO₂).

In some variations, the second electrode may be a cathode of the battery.

In some variations, the cathode of the battery may be an intercalation type electrode including at least one of a lithium-intercalated carbon electrode, a lithium-intercalated silicone electrode, a vanadium oxide electrode, a lithium excess electrode, a graphite electrode, and a graphene electrode.

In some variations, the cathode of the battery may be an alloy type electrode including a tin (Sn).

In some variations, the cathode of the battery may be an air electrode including at least one of an oxygen (O) and air.

In some variations, the at least one acoustic device may be a transducer deposited on a substrate. The transducer may be configured to respond to an electrical input signal by at least applying tension and compression within and/or upon the substrate. The substrate may respond to the tension and the compression by at least oscillating to generate a plurality of acoustic waves.

In some variations, the plurality of acoustic waves may include surface acoustic waves, Lamb waves, flexural waves, thickness mode vibrations, mixed-mode waves, longitudinal waves, shear mode vibrations, and/or bulk wave vibrations.

In some variations, the at least one acoustic device may include one or more pairs of interdigital transducers, a layer of conductive material, and/or one or more contact pins.

In some variations, the substrate may be formed from at least a piezoelectric material.

In some variations, the piezoelectric material may include lithium niobate (LiNbO₃), lithium titanate (Li₂TiO₃), barium titanate (BaTiO₃), lead zirconate titanate (Pb(ZrₓTi₁₋ₓ)O₃ wherein (0≤x≤1)), quartz, aluminum nitride (AlN), langasite, lead magnesium niobate-lead titanate (PMN-PT), lead-free potassium sodium niobate (K_{0.5}Na_{0.5}NbO₃ or KNN), a doped derivative of lead-free potassium sodium niobate, and/or polyvinylidene fluoride (PVDF).

In some variations, the at least one acoustic device may be configured to generate a plurality of acoustic waves having a frequency corresponding to an attenuation length of the plurality of acoustic waves. The attenuation length may correspond to a first length of the first electrode, a second length of the second electrode, and/or a distance between the first electrode and the second electrode.

In some variations, the at least one acoustic device may be integrated inside a case of the battery and/or integrated on the case of the battery.

In some variations, the battery may be a coin cell, a pouch cell, or a cylindrical cell.

In some variations, the battery may be coupled with a circuit configured to drive the at least one acoustic device. The circuit may include an integrated battery charging circuit and an automatic resonance search function.

In some variations, a method may include: receiving a feedback signal responsive to one or more acoustic waves, the one or more acoustic waves generated by the at least one acoustic device comprising the battery, and the feedback signal corresponding to at least a partial reflection of the one or more acoustic waves formed by one or more components on an interior of the battery; determining, based at least on the feedback signal, a morphology of the interior of the battery; and controlling, based at least on the morphology of the interior of the battery, an operation of the battery.

In some variations, the controlling of the operation of the battery may include terminating the operation of the battery in response to the feedback signal indicating a presence of dendrites and/or an air bubble on a surface of the first electrode and/or the second electrode.

In some variations, the controlling of the operation of the battery may include terminating the operation of the battery in response to the feedback signal indicating a presence of detached dendrites, a breakage in a solid electrolyte interface layer, and/or a formation of a protective polymer layer on the at least one acoustic device.

In some variations, the operation of the battery may be terminated by electrically decoupling the battery from an electric load of the battery and/or from another battery in a same battery array.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to rechargeable batteries, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 depicts a comparison between a conventional lithium metal battery and a lithium metal battery having an integrated surface acoustic wave device, in accordance with some example embodiments;

FIG. 2 depicts a comparison of lithium deposition morphology on a copper substrate with and without the presence of surface acoustic waves, in accordance with some example embodiments;

FIG. 3 depicts a comparison of the Coulombic efficiency with and without the presence of surface acoustic waves at various deposition and stripping rates, in accordance with some example embodiments;

FIG. 4 depicts a comparison of the galvanostatic cycling performance of a lithium iron phosphate battery with and without the presence of surface acoustic waves, in accordance with some example embodiments;

FIG. 5 depicts a comparison of the cycling performance of full battery cells with and without the presence of surface acoustic waves, in accordance with some example embodiments;

FIG. 6 depicts a comparison of lithium deposition morphology of a lithium anode with and without the presence of surface acoustic waves, in accordance with some example embodiments;

FIG. 7 depicts a distribution of the flow velocity within a battery having an integrated surface acoustic wave device, in accordance with some example embodiments;

FIG. 8 depicts an example of a battery cell having an integrated surface acoustic wave (SAW) device, in accordance with some example embodiments;

FIG. 9 depicts a comparison of the different states of a surface acoustic wave device immersed in a carbonate-based electrolyte with and without a parlyene coating, in accordance with some example embodiments;

FIG. 10 depicts a comparison of the first cycle deposition performance of a lithium copper battery with and without the presence of surface acoustic waves, in accordance with some example embodiments;

FIG. 11 depicts scanning electron microscope (SEM) images illustrating the operations to obtain lithium electrode porosity, in accordance with some example embodiments;

FIG. 12 depicts a comparison of the change in concentration gradient with and without the presence of surface acoustic waves at different state of charge (SOC) status, in accordance with some example embodiments;

FIG. 13A depicts a comparison of a electrochemistry performance of a pouch cell having an externally integrated surface acoustic wave device and a baseline battery, in accordance with some example embodiments;

FIG. 13B depicts a comparison of a electrochemistry performance of a pouch cell having an internally integrated surface acoustic wave device and a baseline battery, in accordance with some example embodiments;

FIG. 14 depicts a block diagram illustrating an example of a surface acoustic wave battery system, in accordance with some example embodiments;

FIG. 15 depicts a top level description of the circuit blocks forming a surface acoustic wave battery system, in accordance with some example embodiments;

FIG. 16 depicts a circuit diagram illustrating an example of a microcontroller, in accordance with some example embodiments;

FIG. 17 depicts a circuit diagram illustrating an example of a surface acoustic wave driver, in accordance with some example embodiments;

FIG. 18A depicts a circuit diagram illustrating an example of a battery cycler, in accordance with some example embodiments

FIG. 18B depicts a circuit diagram illustrating an example of a battery cycler control circuit, in accordance with some example embodiments;

FIG. 19 depicts a circuit diagram illustrating an example of a power management circuit, in accordance with some example embodiments; and

FIG. 20 depicts a block diagram illustrating an example of an electrical driver system for a surface acoustic wave device, in accordance with some example embodiments.

When practical, similar reference numbers denote similar structures, features, or elements.

### DETAILED DESCRIPTION

The charging of a battery may cause the formation of dendrites. For example, charging a lithium (Li) metal battery may cause the formation of lithium dendrites at the anode of the battery as lithium ions returning to the anode from the cathode form irregular, mossy deposits on the anode. The formation of dendrites may gradually reduce the battery's discharge capacity. Furthermore, the dendrites forming on the anode may eventually puncture the separator to come in contact with the cathode and cause an internal short within the battery. Susceptibility to dendrite formation may therefore diminish the safety, rechargeability, capacity, and lifespan of conventional lithium metal batteries. The risk of dendrites forming in lithium metal batteries may be especially high at high current densities, which renders lithium metal batteries unsuitable for applications requiring a high charging rate.

In some example embodiments, a lithium metal battery may include an integrated surface acoustic wave (SAW) device, which may operate during the charging of the lithium metal battery to suppress the formation of lithium dendrites in the lithium metal battery. The surface acoustic wave device may generate acoustic streaming, which may drive rapid submicron boundary layer mixing flow of the electrolyte adjacent to the anode of the lithium metal battery. This surface acoustic wave driven mixing flow may increase the uniformity of the lithium deposit on the anode of the lithium metal battery including by decreasing the lithium concentration gradient that is present during the charging of the lithium metal battery, even when the lithium metal battery is subject to rapid charging. Notably, this surface acoustic wave driven mixing flow may suppress the formation of lithium dendrites even when the chemical composition of the lithium metal battery, such as the inclusion of a carbonate-based electrolyte (e.g., ethylene carbonate (EC) and diethyl carbonate (DEC) and/or the like), renders the lithium metal battery especially susceptible to dendrite formation. Moreover, the surface acoustic wave device may operate to suppress dendrite formation with minimal power consumption (e.g., approximately 10 mWh/cm²), especially relative to the power that is consumed to charge the lithium metal battery.

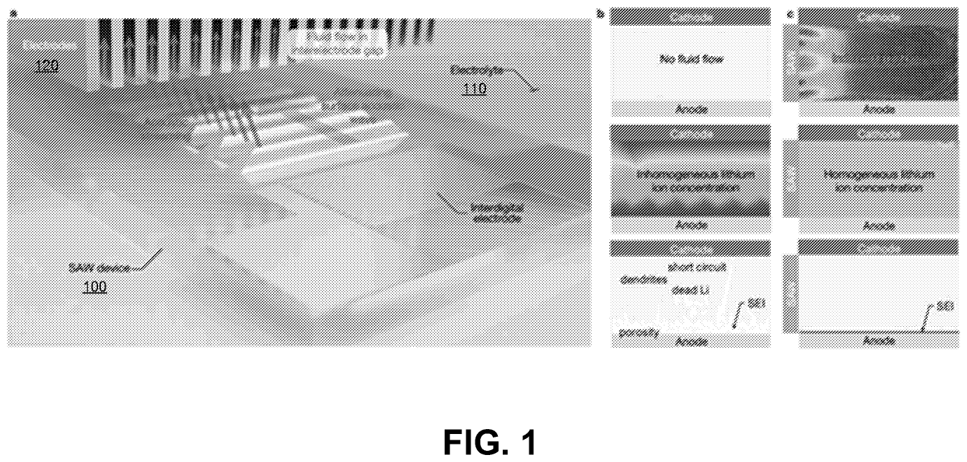

FIG. 1 depicts a comparison between a conventional lithium metal battery and a lithium metal battery having an integrated surface acoustic wave device, in accordance with some example embodiments. Referring to FIG. 1(a), a surface acoustic wave (SAW) device 100 may generate acoustic streaming that drives the flow of an electrolyte 110 in the gaps between the electrodes 120. FIG. 1(b) depicts the fluid flow, ion distribution, and dendrite formation present in a conventional lithium metal battery whereas FIG. 1(c) depicts the fluid flow, ion distribution, and dendrite formation present in a lithium metal battery having an integrated surface acoustic wave device. As shown in FIGS. 1(b)-(c), the stationary electrolyte in a conventional lithium metal battery may permit high ion concentration gradients to develop during charging, which leads to lithium dendrites, dead lithium, lithium metal volume expansion, an uneven solid-electrolyte interface (SEI), and, eventually, a short circuit within the lithium metal battery. Contrastingly, in a lithium metal battery having an integrated surface acoustic wave device, the acoustic streaming generated by the surface acoustic wave device during charging may recirculate the electrolyte to create a homogeneous ion distribution and uniform lithium deposition (e.g., on the anode of the lithium metal battery) during charging.

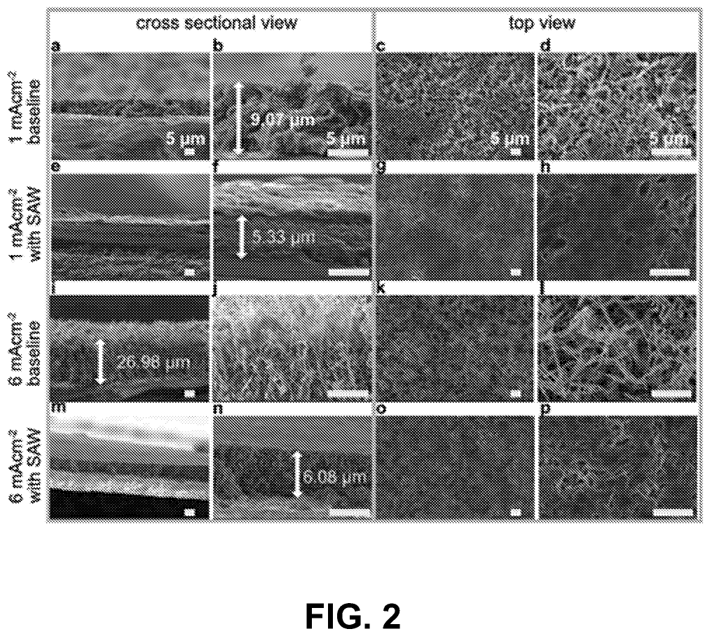

In some example embodiments, the acoustic streaming generate by a surface acoustic wave device may suppress the formation of lithium dendrites in a lithium metal battery even when the chemical composition of the lithium metal battery, such as the inclusion of a carbonate-based electrolyte (e.g., EC/DEC and/or the like), renders the lithium metal battery especially susceptible to dendrite formation. FIG. 2 depicts a comparison of lithium deposition morphology on a copper substrate with and without the presence of surface acoustic waves, in accordance with some example embodiments. A baseline lithium-copper battery without a surface acoustic wave device and a lithium-copper battery with an integrated surface acoustic wave device may be formed to include a carbonate electrolyte (e.g., EC/DEC in 1M LiPF6), which is known to trigger dendrite formation even at low current density rates. The formation of dendrites may be detected based on the respective voltage profiles of the baseline battery and the battery cell having the integrated surface acoustic wave device. Accordingly, an increase in the voltage of the baseline cell may be an indication of dendrite formation whereas the constant voltage exhibited by the lithium-copper battery having the integrated surface acoustic wave device, even at high current densities, may indicate a uniform lithium deposition. The presence of surface acoustic waves may even prevent the steep voltage drop that the baseline battery exhibits at the beginning of the deposition because the surface acoustic waves may minimize the heterogeneous nucleation barrier that is present in the baseline battery.

FIG. 2 depicts scanning electron microscope (SEM) images of the electrodes from the baseline battery and battery with the integrated surface acoustic wave device subsequent to a single deposition cycle. FIGS. 2(a)-(d) depict the baseline battery after lithium was plated onto a copper substrate at a current density of 1 mAcm⁻² (1C) until the areal capacity reaches 1 mAhcm⁻². FIGS. 2(e)-(h)d depicts the battery having the integrated surface acoustic wave device after lithium was plated onto a copper substrate at a current density of 1 mAcm⁻²(1C) until the areal capacity reaches 1 mAhcm⁻². FIGS. 2(i)-(l) depicts the baseline battery after lithium was plated onto a copper substrate at a current density of 6 mA/cm² until an areal capacity of 1 mAh/cm² is achieved. FIGS. 2(m)-(p) depicts the battery having the integrated surface acoustic wave device after lithium was plated onto a copper substrate at a current density of 6 mA/cm² until an areal capacity of 1 mAh/cm² is achieved. It should be appreciated that FIGS. 2(a), (b), (e), (f), (i), (j), (m), and (n) depict cross-sectional views, with FIGS. 2(b), (f), (j), and (n) being close-up views of FIGS. 2(a), (e), (j), and (m), respectively. Meanwhile, FIGS. 2(c), (d), (g), (h), (k), (l), (o), (p) depict top views, with FIGS. 2(d), (h), (l), and (p) being close-up views of FIGS. 2(c), (g), (k), and (o), respectively.

Referring to FIG. 2, the baseline battery charged without surface acoustic waves and the battery that is charged with surface acoustic wave may exhibit a difference in the thickness of the resulting electrodes (e.g.,. 9.1 μm when cycled without surface acoustic waves at a current density of 1 mAcm⁻² current density versus 5.3 μm when cycled with surface acoustic waves). This difference may correspond to the density of the lithium deposit. Theoretically, a 4.85 μm thick lithium deposit may be achieved if the lithium is being deposited without any porosity or dendrites. As such, the density of the lithium deposit achieved in the presence of surface acoustic waves indicate that the surface acoustic waves may improve deposition behavior and morphology. This difference in deposition morphology may also be observed in the top views of the baseline battery and the battery having the integrated surface acoustic wave device. For example, FIGS. 2(g)-(h) show that the deposition morphology of the battery with the integrated surface acoustic wave device may be dense and free of dendrites whereas FIG. 2(c)-(d) show that the deposition morphology of the baseline battery exhibits porosity as well as dendrites.

The difference in the thickness of the electrodes of the baseline battery charged without surface acoustic waves and the battery charged with surface acoustic wave may be even more pronounced at a higher current density (e.g., 6 mAcm⁻²). Whereas the deposition thickness is slightly increased to 6 μm for the battery having the integrated surface acoustic wave device, the deposition thickness of the baseline cell increased dramatically to 27 μm. This significant change in the thickness of the baseline battery may be an indication of dendrite formation and loose lithium deposition. When viewed from the top, the lithium dendrites may appear thinner and more porous when the baseline battery is subjected to a higher current density. Contrastingly, the battery having the integrated surface acoustic wave device may exhibit a more homogeneous morphology including the presence of lithium chunks indicative of the formation of a homogeneous and stable solid-electrolyte interface (SEI).

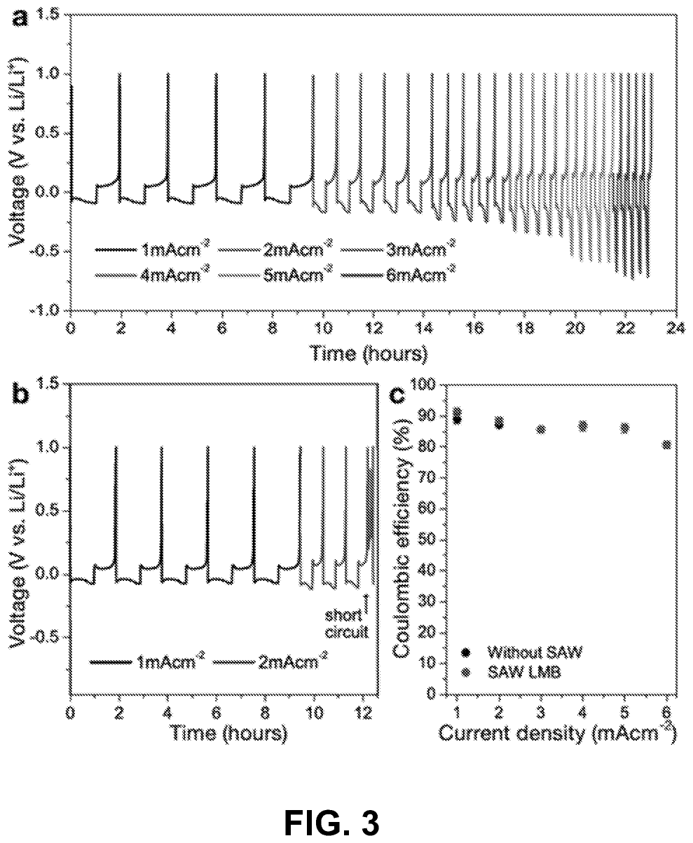

FIG. 3 depicts a comparison of the Coulombic efficiency with and without the presence of surface acoustic waves at various deposition and stripping rates, in accordance with some example embodiments. The baseline battery and the battery having the integrated surface acoustic wave device were cycled at increasing current densities (e.g., starting from 1 mAcm⁻² and increasing to 2,3,4,5,6 mAcm⁻²) until an areal capacitiy of 1 mAhcm⁻² is achieved and stripped back to 1 volt. FIG. 3(a) depicts the resulting electrochemistry profile of the battery having the integrated surface acoustic wave device whereas FIG. 3(b) depicts the electrochemistry profile of baseline battery. As shown in FIG. 3, the baseline battery may begin to exhibit an unstable electrochemistry profile starting at the third cycle during which the cells are subject to a current density of 2 mAcm⁻². FIG. 3(c) depicts the average Coulumbic efficiency of baseline battery (black dots) and the battery having the integrated surface acoustic wave device (green dots) with error bars as a function of current densities, which are summarized from FIGS. 3(a)-(b).

The cycleability of the battery having the integrated surface acoustic wave device may be examined at different cycle rates with a carbonate-based electrolyte (e.g., 1 M LiPF₆ in EC/DEC). While the battery having the integrated surface acoustic wave device may exhibit an average of 91.5% Coulombic efficiency at 1 mAcm⁻², the baseline battery may exhibit an 88% Coulombic efficiency. When cycled at a current density of 2 mAcm⁻², the battery having the integrated surface acoustic wave device may retain an 89% Coulombic efficiency while the baseline battery may exhibit an 87% Coloumbic efficiency after the first two cycles. Moreover, the baseline cell may begin to exhibit an unstable electrochemistry profile at the third cycle at the current density of 2 mAcm⁻². Contrastingly, the battery having the integrated surface acoustic wave device may maintain optimal cycling performance throughout including by continuing to exhibit a stable electrochemistry profile. For example, the battery having the integrated surface acoustic wave device may maintain a >80% Coloumbic efficiency throughout the cycle period even at high charge rates whereas the Coloumbic efficiency of the baseline battery may degrade even at relatively low charge rates.

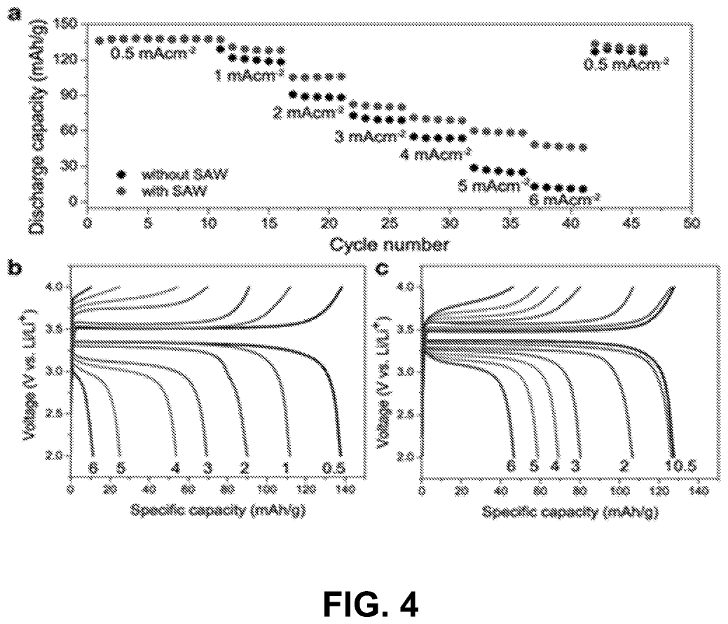

FIG. 4 depicts a comparison of the galvanostatic cycling performance of a lithium iron phosphate battery with and without the presence of surface acoustic waves, in accordance with some example embodiments. FIG. 4 depicts the galvanostatic cycling performance of a baseline lithium iron phosphate (LiFePO₄) battery without an integrated surface acoustic wave device and a lithium iron phosphate battery with an integrated surface acoustic wave device, each of which having an carbonate-based electrolyte (e.g., EC/DEC and/or the like), at different cycling rates. In particular, FIG. 4(a) depicts a comparison of the discharge capacity the baseline battery and the battery having the integrated surface acoustic wave device at charging densities of 0.5, 1, 2, 3, 4, 5, 6, and back to 0.5 mAcm⁻² (where 1 mAcm⁻² corresponds to 1 C). Meanwhile, the charge and discharge profiles at the last cycle of each current density (which are 10, 15, 20, 25, 30, 35, 40, and 45th cycles) for the baseline battery and the battery having the integrated surface acoustic wave device are shown in FIGS. 4(b) and (c), respectively.

As shown in FIG. 4, the baseline battery and the lithium iron phosphate battery having the integrated surface acoustic wave device may exhibit similar discharge capacities (e.g., 137 mAh/g) at a low cycle rate (e.g., 0.5 mAcm−² or 0.5C). This may be attributable to the presence of a small lithium ion concentration gradient at low current densities, even for the baseline battery without the integrated surface acoustic wave device. However, a difference in discharge capacity may begin to manifest at higher current densities (e.g., greater than 1 mAcm−2). As such, the current density of 1 mAcm⁻² may be considered a critical value where the dendrites may begin to form and when surface acoustic waves may begin to influence the cycling performance of a battery cell.

For example, the lithium iron phosphate battery having the integrated surface acoustic wave device may deliver 130 mAh/g at 1 mAcm⁻² current density while the baseline battery may deliver 120 mAcm⁻² at 1 mAcm⁻² current density. Moreover, the decrease in discharge capacity may be more precipitous for the baseline battery when the induced current density is increased. For instance, the baseline battery delivered 8.3% discharge capacity when the current density is increased from 1 mAcm⁻² to 6 mAcm⁻². Contrastingly, the battery having the integrated surface acoustic wave device delivered 42% discharge capacity when the current density increased from 1 mAcm⁻² to 6 mAcm⁻².

Referring again to FIG. 4, the lithium iron phosphate battery having the integrated surface acoustic wave device may recover to a higher discharge capacity when the current density is subsequently lowered. For example, although the baseline battery also recovered some of its discharge capacity when returned to a lower current density, the recovered discharge capacity of the baseline battery is lower. That the batteries recovered their discharge capacity may indicate a lack of permanent damage form the rapid charge and discharge. Nevertheless, the low discharge capacity of the baseline battery at high charge rates may arise from the low diffusion rate and high lithium concentration gradient present in the baseline battery. By contrast, the higher discharge capacity of the battery having the integrated surface acoustic wave device may be attributable primarily to the lithium ions being closer to fully charge due to the acoustic streaming at the charge state. The phenomenon is again shown to be present in the charge and discharge profiles depicted in FIGS. 4(b) and (c). Referring to FIGS. 4(b) and (c), the voltage hysteresis increased dramatically for the baseline battery at high cycle rates. The voltage hysteresis increased to 1.02 V at a current density of 6 mAcm⁻², which is 100% greater than that of the battery having the integrated surface acoustic wave device. A large voltage hysteresis associated with the baseline battery may be indicative of poor lithium ion diffusivity in the absence of surface acoustic waves.

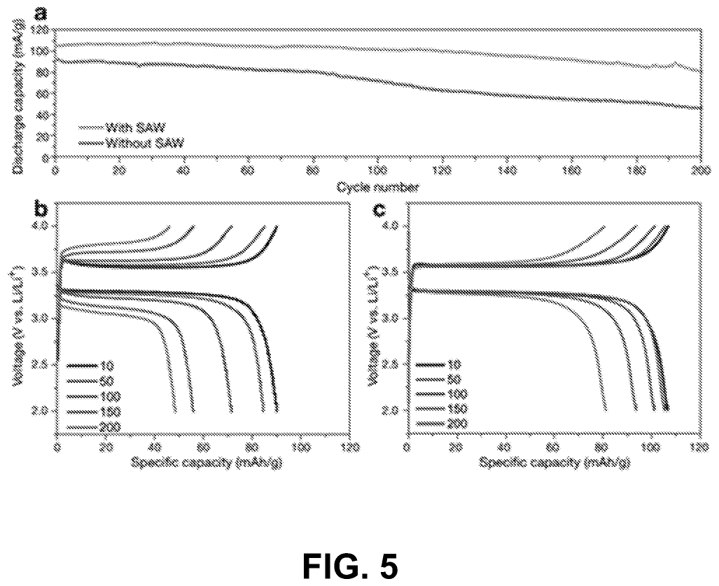

FIG. 5 depicts a comparison of the cycling performance of full battery cells with and without the presence of surface acoustic waves, in accordance with some example embodiments. FIG. 5 depicts the cycling performance of full batteries having a lithium anode and a lithium iron phosphate (LFP) cathode being subject to a current density of 2mAcm⁻² (equivalent to 2C) for 200 cycles. The full lithium iron phosphate battery having the integrated surface acoustic wave device may deliver a 110 mAh/g initial discharge capacity while the baseline lithium iron phosphate battery may deliver a 90 mAh/g initial discharge capacity. Moreover, FIG. 5(a) shows that the battery having the integrated surface acoustic wave device may retain 80% of its discharge capacity over 200 cycles whereas the baseline battery is able to retain 53% of its initial discharge capacity. The galvanostatic profile of the baseline lithium iron phosphate battery at 10, 50, 100, 150, and 200 cycles is shown in FIG. 5(b) while the galvanostatic profile of the battery cell having the integrated surface acoustic wave device at 10, 50, 100, 150, and 200 cycles is shown in FIG. 5(c).

Referring again to FIG. 5(a), cycle performance may be improved with the presence of surface acoustic waves. For example, as shown in FIG. 5(a), the discharge capacity of the battery having the integrated surface acoustic wave device may be higher throughout the 200 cycles, with the initial discharge capacity of the battery being 20% higher than that of the baseline battery without the integrated surface acoustic wave device. The battery having the integrated surface acoustic wave device may also retain its discharge capacity better than the baseline battery. For instance, FIG. 5(a) shows the battery having the integrated surface acoustic wave device retaining 82% of its initial discharge capacity after 200 cycles whereas the baseline battery is only able to retain 51% of its initial discharge capacity.

The difference in discharge capacity and the retention of discharge capacity may be observed in the voltage profile of the baseline battery shown in FIG. 5(b) and the voltage profile of the battery having the integrated surface acoustic wave device shown in FIG. 5(c). FIG. 5(b) shows an increase in cell polarization with each successive cycle. In particular, a 63% increase in the polarization voltage present between the 10^{th} (0.28 V) to the 200^{th} cycle (0.77 V) of the baseline battery. This increase in polarization may indicate the presence of lithium dendrites and may thus be associated with the drop in discharge capacity over successive cycles. Contrastingly, FIG. 5(c) shows a stabilization of polarization in the voltage profile of the battery having the integrated surface acoustic wave device. Notably, the polarization voltage at the 10^{th} cycle is 0.266 V and remains at 0.298V at the 200^{th} cycle. This minimal 10% increase in polarization voltage over 200 cycles may indicate stable cycle performance.

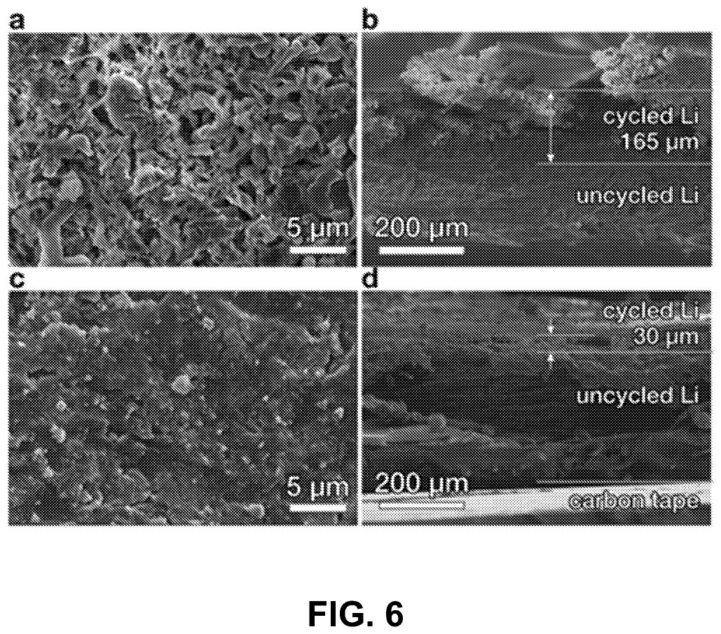

FIG. 6 depicts a comparison of the lithium deposition of a lithium anode with and without the presence of surface acoustic waves, in accordance with some example embodiments. For example, FIG. 6(a) depicts a scanning electron microscope (SEM) image of the lithium electrode of the baseline battery, which exhibits loose lithium deposition and the presence of lithium dendrites. Contrastingly, FIG. 6(c) depicts a scanning electron microscope image of the lithium electrode of the battery having the integrated surface acoustic wave device, which exhibits a denser and smoother deposition of lithium.

When the porosity of the lithium deposits is quantified, the lithium electrode from the baseline battery may exhibit a porosity of 0.541 whereas the porosity of the lithium electrode in the battery having the integrated surface acoustic wave device is significantly lower at 0.0367. The difference in the porosity and morphology of the lithium deposits may also be observed in the cross-sectional views shown in FIGS. 6(b) and (d). For example, the baseline battery had a lithium deposit that is 165 μm thick, indicating that 66% of the lithium in the battery is consumed due to dendrite formation and electrolyte consumption. Contrastingly, only consumed 10% of the lithium in the battery having the integrated surface acoustic wave device is consumed after 200 cycles due to dendrite formation and electrolyte consumption.

The performance of a lithium metal battery may be contingent upon its diffusion properties, which directly affect the charge and discharge rate, capacity, and cycling stability of the lithium metal battery. In most batteries, the fluid velocity in the electrolyte, u, may be negligible. As such, the lithium ions (Li⁺) that are depleted from the electrolyte into the anode due to the ionic migration that occurs charging may be replaced through diffusion. However, in a lithium metal battery that is being subject to rapid charging, diffusion may be too slow to overcome electrolyte ion depletion. As such, the charge rate of the lithium metal battery may be maximized by recirculating the electrolyte to improve ion transport. For example, electrolyte recirculation may be achieved by introducing surface acoustic wave driven streaming, which may increase the fluid velocity u of the electrolyte, for example, zero to approximately 1 m/s. Nevertheless, in some example embodiments, the surface acoustic wave device may be configured to generate surface acoustic waves that maximizes ion transport while suppressing the formation of lithium dendrites.

Conventional models for dendrite formation in electrochemical cells typically cast dendrite formation as a spatially one-dimensional diffusion problem, conserving the number of ions in the electrolyte subject to a predefined electrical current through the cell. The current may be a function of the electrical potential difference between the electrodes. Contrastingly, according to some example embodiments, the flow of electrolyte, especially impinging flows, may inhibit the early growth of small dendrites. Hence, the convective and diffusive transport of ions in the electrochemical cell may be modeled transverse as well as parallel to an electrode. The cell may be assumed to be near the limiting current density and that slight morphological imperfections along the electrode form “hotspots” that locally enhance the rate by which metal ions adsorb onto the electrode and allow for the initial growth of dendrites. Moreover, acoustically-driven flow in the cell may be assumed to affect the distribution of ions along the electrode in the vicinity of these hotspots.

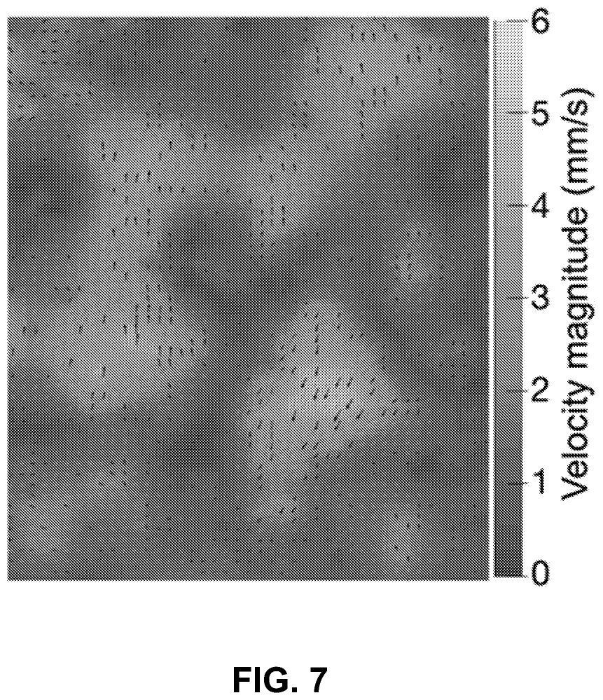

FIG. 7 depicts a distribution of the flow velocity within a battery having an integrated surface acoustic wave device, in accordance with some example embodiments. Referring to FIG. 7, while the surface acoustic wave device is operated at 474 mW, the mean fluid velocity within the battery may be 5 mm/s.

The attenuation length of the sound wave in the electrolyte after its generation from leakage from the surface acoustic wave device may be 4π²f²/c³_{sound})×(4μ/3p)⁻¹≈1 cm in the electrolyte solution, where f c_{sound}, μ, and p denote the frequency, the speed of sound, the viscosity, and the density of the electrolyte solution, 1.22 g/cm³, respectively. The acoustic waves may propagate in the fluid electrolyte over a length scale roughly corresponding to the size of the battery electrodes, a consequence of choosing the 100 MHz operating frequency for the surface acoustic wave device knowing the size of the prototype battery. The acoustic streaming may be most akin to Eckart streaming, due to the lateral confinement and presence of acoustic attenuation through the bulk of the fluid. The experimental flow field may include many vortical cells of characteristic length and velocity δ and u_{c}, respectively. Moreover, the characteristic streaming velocity may be assumed to be u_{c}≈5 mm/s based on the experimental data, and the thickness of each electrolyte chamber in the battery, i.e., L=50 μm, as a characteristic length. With a 1M LiPF₆ in EC:DEC electrolyte, the Reynolds number may be Re=pu_{c}L/μ≈0.2-2, indicating laminar, almost viscous, flow as one might expect from the dimensions of the structure.

However, taking the diffusion coefficient of the ions to be of the order of magnitude of 10⁻⁹ m²/s may indicate strong ion convection and potentially an ion transport boundary layer of a thickness of l≈0.1-1 μm. This conclusion may follow from the requirement that the leading order convective and diffusive components in the transport equations must become comparable in magnitude within the boundary layer, which is satisfied by requiring that the corresponding Peclet number in the boundary layer is u_{c}l/D≈1.

The analysis may be simplified by assuming a simple shear flow of the characteristic velocity u_{c}. The small thickness of the boundary layer in comparison to the gap between the electrodes and the lack of excess pressure therein supports, at least locally, the assumption for simple shear flow.

The steady mass transport of ions, assuming the electrical field in the battery is effectively screened by the high electrolyte concentration, is governed by Equation (1) below.

u·|∇c=D∇²c. (1)

wherein c, u, D may denote ion concentration, velocity field, and the constant ion diffusion coefficient, respectively.

[84] The problem may be simplified by further assuming a 2D problem, in which the x coordinate is along the flow in the boundary layer and the y coordinate traverses the electrodes, which are assumed to be flat and parallel (prior to the physical growth of dendrites). As Equations (2) and (3) below show, the problem may be solved subject to the mass conservation of metal ions in the electrolyte and a harmonic variation in ion concentration along the surface of the lithium electrode, which is associated with local ion depletion areas in the vicinity of hotspots for the growth of dendrites.

$$\frac{\text{?}}{\text{?}} \int \int \text{?} and \qquad ( 2 )$$

$$\text{?} \qquad ( 3 )$$

$$\text{?} \text{indicates text missing or illegible when filed}$$

wherein A may denote the area between the electrodes along the x and y coordinates in a 2D view of the system, c_{bulk} is the concentration of lithium ions in the electrolyte, ∈ is a small perturbation parameter of the excess ion depletion near hotspots with compare to the level of ion depletion away from hotspots, and k is a perturbation wavenumber of ion depletion, which physically may be taken to account for the density of the hotspots along the Li electrode with a corresponding wavelength of 2π/k that is associated with the characteristic separation between hotspots. The surface of the lithium electrode is given at y=0.

In these expressions, localized minima along the lithium electrodes are permitted, where the ion concentration fully vanishes and hence supports the hotspots. The velocity field in the boundary layer is taken to be u=βyeₓ and v=Oe_{y}, where u and v are the components of the velocity field along the e^{x} and e^{y} unit vector directions associated with the x and y coordinates, respectively, and β≈u_{c}/δ is the shear rate along the y coordinate, where δ is a characteristic length of the flow in the boundary layer. The solution of this problem subject to δ=0 (no flow) and δ>0 (simple shear flow in the boundary layer) is provided in the supporting information.

In the absence of flow, the diffusion-limited flux of ions to the electrode, −i, may be given by Equation (4) below.

$$\text{?} \qquad ( 4 )$$

$$\text{?} \text{indicates text missing or illegible when filed}$$

wherein the negative sign in front of I appears because the flux of ions to the electrode is along the −y axis direction. The flux of ions is locally enhanced near the hotspots, suggesting the initial growth of dendrites in this case may be inevitable.

The presence of flow near the lithium electrode may enhance the advection of lithium ions to the electrode in a manner proportional to Pe^{1/3}, wherein Pe≡u_{c}l/D is the Peclet number. In addition, the flow may further enhance the local transport of lithium ions to the hotspots in a manner proportional to Pe^{1/3}. This result may be consistent with the observation that the enhanced convection of ions along the electrode to the hotspots decreases variations in ion concentration that would otherwise arise. The overall rate of lithium ion adsorption onto the electrode may be given by Equation (5) below.

$$\text{?}$$

$$\text{?} \text{indicates text missing or illegible when filed}$$

where the assumption may be that ∈≈Pe^{-2/3} (albeit similar result appears requiring that 1>>∈>>Pe^{-2/3}) and the function Γ( ) is the Euler Gamma function, in which Γ(⅓)≈2.68 and Γ(⅙)≈5.57.

The first term on the right may indicate the spatially monotonic convective contribution of ion flux to a flat homogeneous electrode and the second term indicates the correction to the spatially non-monotonic convective contribution to the ion flux due to the presence of the hotspots. The third term given simply as O(∈) is an additional convective contribution to the ion flux, which is spatially monotonic and may be obtained numerically. The first and third terms may be products of similarity analysis and hence are mathematically singular at the origins, x=0, and hence the expression for the current in Equation (5) may still be physically valid far from the origin.

The mechanism by which flow inhibits the growth of dendrites may be counterintuitive. The flow enhances the flux of lithium ions (Li³⁰ ) to the electrode and particularly to the hotspots where dendrites may grow, as given independently by the first and second terms on the right side of Equation (5), respectively. The ion flux is spatially perturbed by ion depletion next to hotspots for the growth of dendrites, which is given in the second term in the equation. However, the leading order convection term, which decays like x^{-1/3} along the electrode, eliminates localized ion flux maxima and hence is the key to the inhibition of dendrites' growth. The combined contribution of both terms eliminates localized ion transport maxima to the electrode and hence eliminates spatially localized growth spots—dendrites—on the electrode.

However, this suppression of dendrite growth may only be over a finite length of the electrode from x=0, where the shear flow (or alternatively the electrode) commences, to x<x_{crit}. As x increases, the second of the two terms in Equation (5) may become dominant and the hotspots at x≥x_{crit} will begin to allow dendrite growth. To determine this critical length, we require the slope of ion flux to not change sign with respect to x along the electrode, such that d (−i)/dx<0, thus avoiding localized ion flux maxima along the electrode. Substituting Equation (5) into the non-equality, replacing the spatial derivative of the term sin(kx)−√3 cos(kx) ny its numerical upper bound, 2, and ignoring the second order (O(∈)) spatially monotonic contributions to ion flux along the electrode surface, thus comparing between the contribution of the leading order spatially monotonic ion flux and the leading order (harmonic) contribution to the ion flux from the presence of dendrites, gives the expression below.

$${x}_{crit} = {( \frac{6 ϵ {k}^{4 / 3} β}{α} )}^{- 3 / 4} \approx 0.35 {k}^{- 1} {ϵ}^{- 3 / 4} \approx 0.35 {k}^{- 1} P {e}^{1 / 2} ,$$

wherein α≡3^{1/3}(1−∈)/Γ(⅓) and β≡√π(3/2)^{1/3}/Γ(⅙).

The correction to the ion flux due to the presence of hotspots in Equation (5) and in the corresponding estimate of the dendrite free length of the electrode, x_{crit}, are qualitative results. Their quantitative magnitude may be given from the requirement that the contribution of ion depletion (next to hotspots) to the ion flux appears in the first correction (of the order of ∈≈Pe^{-2/3}) to the leading order (O(1)) convective result. Hence, x_{crit} indicates that the excitation of flow near the electrode inhibits the growth of dendrites but to a limited electrode length, which is dependent on the properties of the electrode. In particular, x_{crit} may increase when reducing the density of hotspots and their intensity, that is, reducing the excess of ion depletion next to the hotspots. Alternatively, it is clear that increasing flow intensity further increases x_{crit}. The curious result here is that this length is independent of the specifics of the flow, but only if the Peclet number is significantly greater than one. Here, the means to ensure the Peclet number is sufficiently large may be acoustic streaming.

Accordingly, in some example embodiments, the frequency of the surface acoustic wave device may be selected to ensure the length scale of attenuation of the acoustic wave matches the distance along the interelectrode gap (e.g., the length of the electrodes, the distance between the electrodes, and/or the like) the flow needs to be driven. The integration of small, high-frequency ultrasound generators to drive electrolyte flow within the inter-electrode gaps may give rise to ion flux distributions that render potential locations of dendrite growth stable within a specific distance from the ultrasound source. The distance may be independent of the details of the flow as long as the Peclet number is sufficiently large. This configuration may be feasible with the acoustic streaming induced by a surface acoustic wave device, even with rapid charge rates and the choice of electrode materials that would normally be considered unrealistic. The lithium copper battery, as an example, may be capable of cycling at a current density of 6 mAcm⁻² while maintain a Coulombic efficiency above 80% throughout. Similarly, the lithium iron phosphate (LiFePO₄) configuration may be capable of delivering a 95 mAh/g discharge capacity after 100 cycles at 2C charge and discharge rates.

As noted, in some example embodiments, a battery may be fabricated to include an integrated surface acoustic wave device. For example, to fabricate the lithium copper battery described with respect to FIGS. 2-3, a 10 μm thick copper electrode may be rinsed with acetone to remove surface impurities and oxides before using as an electrode while a 100 μm thick lithium anode may be scrapped to remove oxide layers before serving as an electrode. A lithium iron phosphate (LFP) electrode may be prepared by mixing lithium iron phosphate powder, polyvinylidene fluoride (PVDF) and carbon black (C) at a respective ratio of 75%:10%:15%. The powders may be mixed with N-methyl-2-pyrrolidone (NMP) as a solvent to produce a slurry that is cast on an aluminum foil before being dried in a vacuum oven for 12 hours. The average mass loading may be around 3.1 mgcm⁻². The electrolyte that is used may be commercial grade 1M solution of lithium hexafluorophosphate (LiPF₆) in 1:1 (w/w) mixture of ethylene carbonate (EC) and diethyl carbonate (DEC) (BASF). Finally, a Celgard 480 separator (Celgard Incorporation) may be interposed between the cathode and anode.

A surface acoustic wave device may be fabricated through a lift-off lithography process to deposit, for example, twenty-eight pairs of un-weighted gold chromium (Au/Cr) fingers to form an optimal interdigital transducer (IDT) onto a 500 μm thick 127.68° Y-rotated, X-propagating cut lithium niobate substrate (LiNbO3 (LN), Roditi). The surface acoustic wave device may be coated with parylene C using chemical vapor deposition to prevent the reactions with the electrolyte present in the battery. The baseline battery as well as the battery including the integrated surface acoustic wave device may be assembled inside an argon-filled glovebox, where moisture level and oxygen level are maintained at <1 ppm. The housing for the batteries may include nut, back ferrule, front ferrule, and body for sealing the electrolyte and electrode from exposure to air. Moreover, the current collectors used for the batteries may be formed from stainless steel rods.

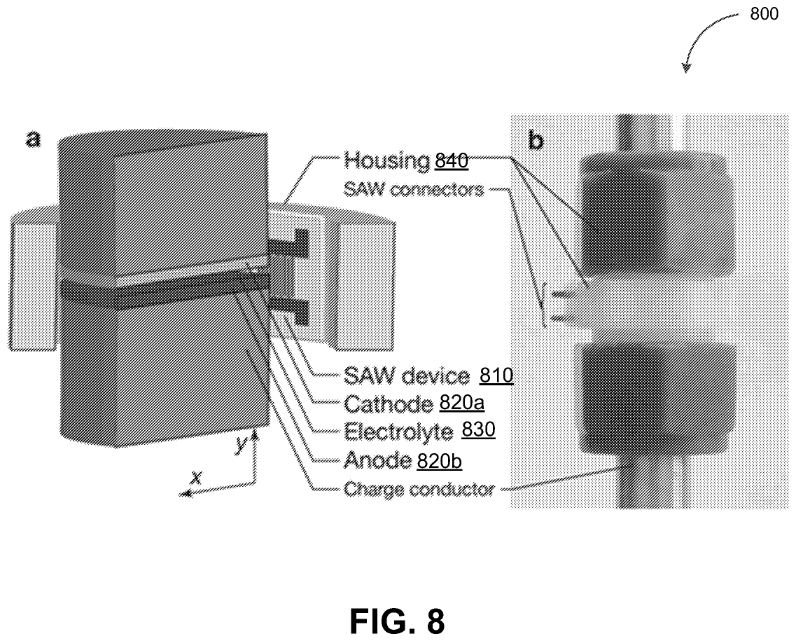

To further illustrate, FIG. 8 depicts an example of a battery cell 800 having an integrated surface acoustic wave (SAW) device 810. As shown in FIG. 8, the battery cell 800 may also include a first electrode 820a (e.g., a cathode), a second electrode 820b (e.g., an anode), and an electrolyte 830. The surface acoustic wave device 810, the first electrode 820a (e.g., the cathode), the second electrode 820b (e.g., the anode), and the electrolyte 830 may be disposed inside a housing 840 of the battery cell 800. It should be appreciated that the battery cell 800 may be a lithium (Li) battery, a lithium-ion battery, a potassium (K) battery, a magnesium (Mg) battery, a copper (Cu) battery, a zinc (Zn) battery, a sodium (Na) battery, a potassium (K) battery, and/or the like. Each of tje first electrode 820a and the second electrode 820b may be a metal electrode, a cation-intercalated composite electrode, an air electrode, a graphite electrode, a graphene electrode, a lithium-intercalated carbon electrode, a lithium-intercalated silicone electrode, a sulphur electrode, a tungsten electrode, a silicon electrode, a nitride electrode, a vanadium oxide electrode, a lithium excess electrode, and/or the like.

In some example embodiments, the surface acoustic wave device 810 may be configured to generate surface acoustic waves. However, it should be appreciated that the surface acoustic wave device 810 may also generate other types of acoustic waves including, for example, Lamb waves, flexural waves, thickness mode vibrations, mixed-mode waves, longitudinal waves, shear mode vibrations, and/or bulk wave vibrations. The surface acoustic wave device 810 may include a transducer deposited on a substrate. The transducer may be configured to respond to an electrical input signal by at least applying tension and compression within and/or upon the substrate. The substrate may respond to the tension and the compression by at least oscillating to generate the plurality of surface acoustic waves. The transducer may include one or more pairs of interdigital transducers, a layer of conductive material, and/or one or more contact pins. The substrate may be formed from a piezoelectric material including, for example, lithium niobate (LiNbO₃), lithium titanate (Li₂TiO₃), barium titanate (BaTiO₃), lead zirconate titanate (Pb(ZrₓTi₁₋ₓ)O₃ wherein (0≤x≤1)), quartz, aluminum nitride (AlN), polyvinylidene fluoride (PVDF), and/or the like.

In some example embodiments, the surface acoustic wave device, for example, the surface acoustic wave device 810, may be integrated inside or outside of the case of a battery. When the surface acoustic wave device is integrated outside of the case of a battery, one or more coupling agents may be used to couple surface acoustic waves into the battery. It should be appreciated that the surface acoustic wave device may be integrated into various different types of battery cells in a variety of different manner. For example, for a pouch cell, the surface acoustic wave device may be attached onto any surface of the pouch cell. For a cylindrical cell, the surface acoustic wave device may be positioned from the bottom and/or top flat surfaces, or along the edges of the cylinder rolls. For a coin cell, the surface acoustic device may be positioned onto the flat surfaces or the edge of the round shape of the coin cell.

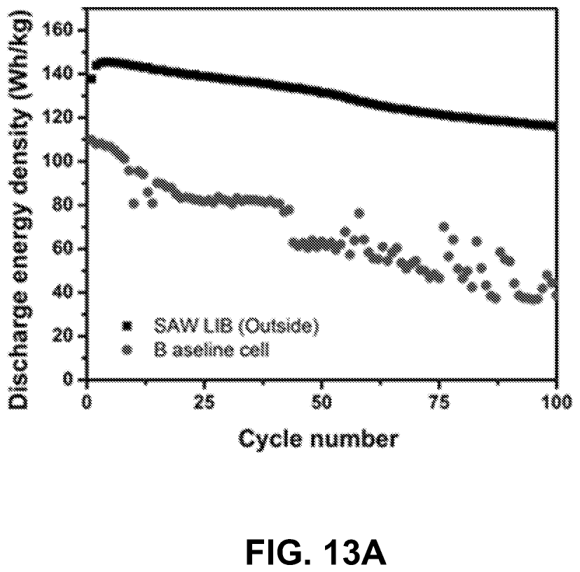

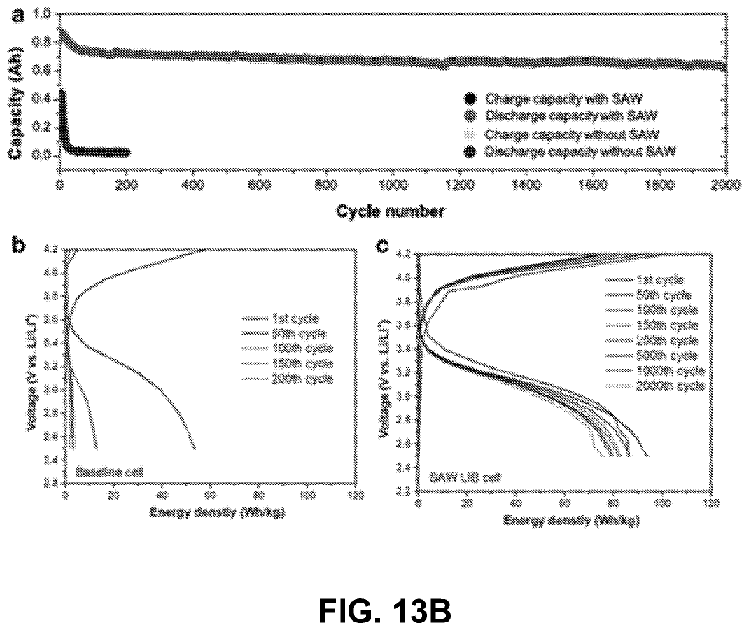

FIG. 13A depicts a comparison of a electrochemistry performance of a pouch cell having an externally integrated surface acoustic wave device and a baseline battery, in accordance with some example embodiments. Referring to FIG. 13A, the electrochemistry performance of a pouch cell, in this case a lithium ion battery, having a surface acoustic wave device integrated to its outer case, for example, packing surface may be compared to that of a baseline cell without an integrated surface acoustic wave device. The surface acoustic waves may be coupled through an ultrasound gel into the battery, generating acoustic streaming inside the battery. The battery may be tested under 10 minutes charge time and 3 hours discharge time. FIG. 13B shows a clear improvement on energy density and capacity retention in the battery having the externally integrated surface acoustic wave device. The externally integrated surface acoustic wave device may enable the lithium ion battery to deliver a 140 Wh/kg energy density with a 33% capacity retention over 100 cycles whereas the baseline battery was only able to deliver a 110 Wh/kg energy density with a 20% capacity retention over 100 cycles. This improvement in cycling performance may be attributable to the acoustic streaming of electrolyte, which is provided by the externally integrated surface acoustic wave device.

FIG. 13B depicts a comparison of a electrochemistry performance of a pouch cell having an internally integrated surface acoustic wave device and a baseline battery, in accordance with some example embodiments. Referring to FIG. 13B, a lithium ion pouch cell with an internally integrated surface acoustic wave device and a baseline battery without an integrated surface acoustic wave device may be cycled at 10 minutes recharge time. FIG. 13B shows that when compared to the baseline battery without the integrated surface acoustic wave device, the lithium ion pouch cell having the internally integrated surface acoustic wave device exhibits a superior cycling performance including delivering a 100% higher energy density (e.g., 100˜Wh/kg with surface acoustic waves versus. 55˜Wh/kg in the baseline battery) and prolonged cycle life (2000 cycles with 80% capacity retention with surface acoustic waves versus almost zero capacity retention after 200 cycles for the baseline battery).

In some example embodiments, the morphology of the interior of the battery having the integrated surface acoustic wave device may be determined based at least on a feedback signal formed by a reflection of one or more surface acoustic waves being reflected off the surface of the electrodes of the battery. For example, the surface acoustic wave device may generate one or more surface acoustic waves while the battery is being charged and/or discharged. These surface acoustic waves may propagate, through an electrolyte filling the interior of the battery, toward the one or more electrodes of the battery before being reflected off of the surface of the one or more electrodes. The surface acoustic wave device may be further configured to detect the feedback signals formed by the reflection of these acoustic waves off the surface of the one or more electrodes.

The surface acoustic wave device may exhibit piezoelectric properties. For example, the surface acoustic wave device may include a transducer (e.g., one or more pairs of metallic interdigital transducers, a layer of conductive material, contact pins, and/or the like) deposited on a substrate formed from a piezoelectric material. As such, the surface acoustic wave device may generate the plurality of acoustic waves by at least converting an electrical signal into mechanical energy embodied by the acoustic waves. Furthermore, the surface acoustic wave device may detect the feedback signals by at least converting the mechanical energy of the feedback signals into an electrical signal. However, it should be appreciated that instead of and/or in addition to the surface acoustic wave device, a different detector may be used to detect the feedback signals.

In some example embodiments, the battery having the integrated surface acoustic wave device may be coupled with a controller configured to: determine, based at least on the feedback signal, a morphology of an interior of the battery; and control, based at least on the morphology, an operation of the battery. The controller may be configured to terminate the operation of the battery in response to the feedback signal indicating an adverse morphology including, for example, the presence of dendrites and/or air bubbles on the surface of the first electrode and/or the second electrode. In response to detecting the presence of adverse morphology, the controller may terminate the operation of the battery by at least electrically decoupling the battery from an electric load of the battery and/or another battery in a same battery array.

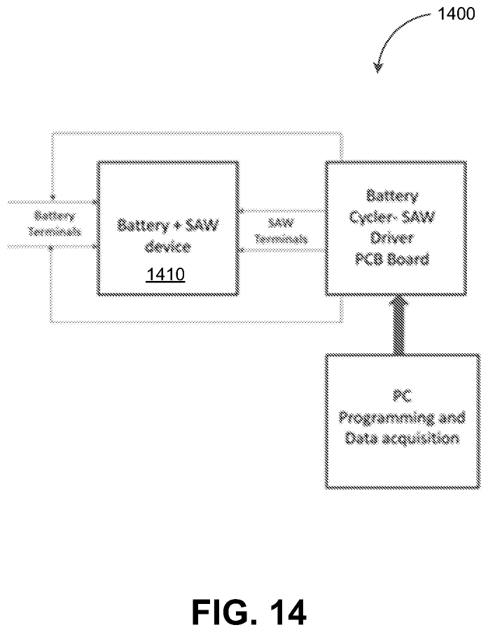

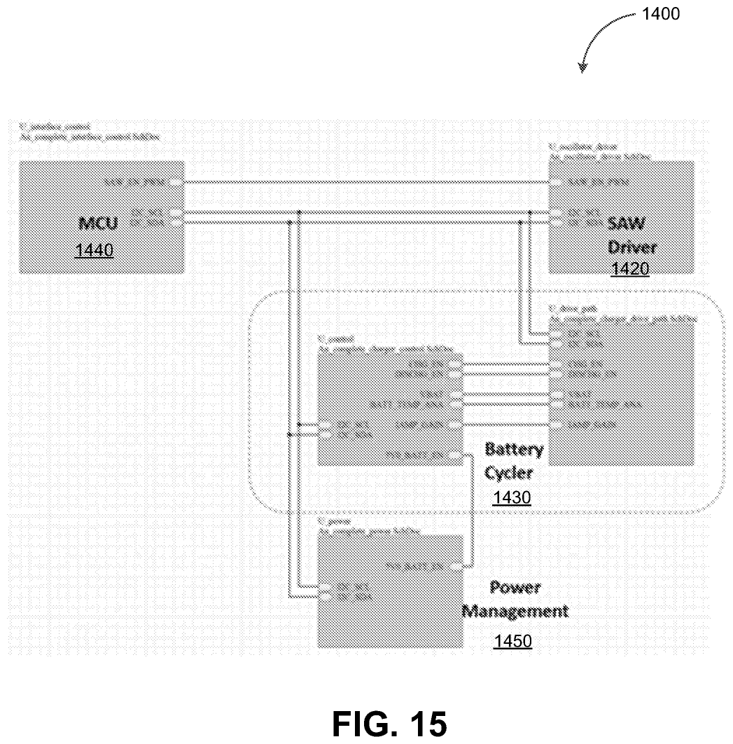

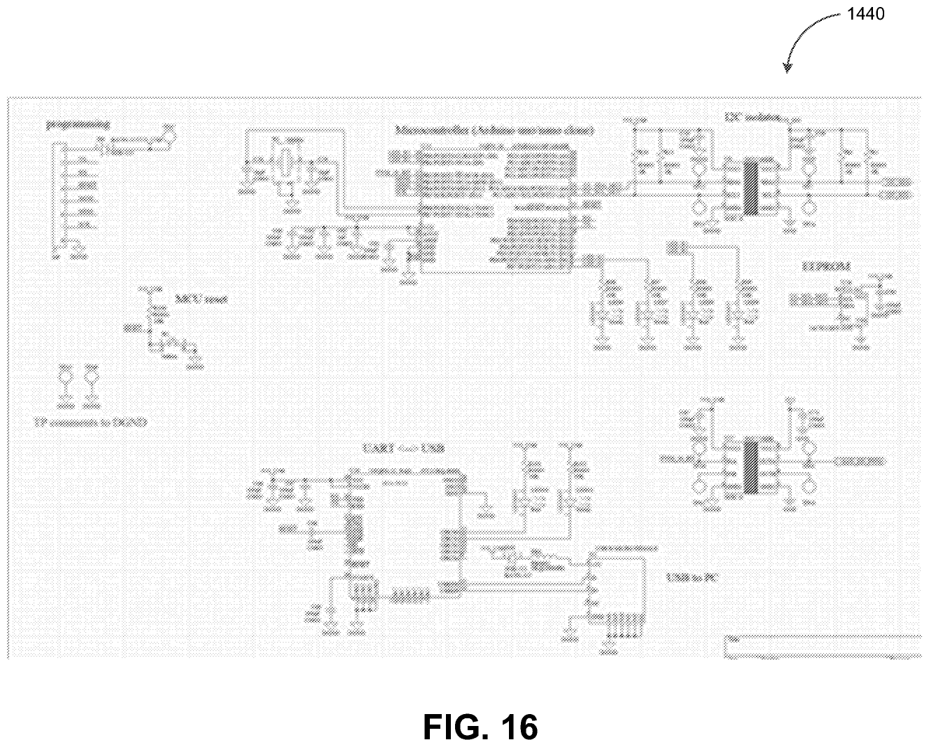

FIG. 14 depicts a block diagram illustrating an example of a surface acoustic wave battery system 1400, in accordance with some example embodiments. A top level description of the circuit blocks in the surface acoustic wave battery system 1400 is shown in FIG. 15. Referring to FIGS. 14-15, the surface acoustic wave battery system 1400 may include a software-controlled board to perform interactive battery cycling and surface acoustic waveform generation simultaneously. For example, the example of the surface acoustic wave battery system 1400 shown in FIGS. 14-15 may include a surface acoustic wave driver 1420 and battery cycler 1430 that is coupled to a battery having an integrated surface acoustic wave device 1410 and controlled by a microcontroller 1440. Different parts of this circuit may require different supply voltages. This may be provided by a power management block 1450 which takes, for example, a 12 VDC input from a wall outlet. The design of the microcontroller 1430, which is shown in FIG. 16, may be made similar to Arduino nano and programmed using Arduino software. The microcontroller 1430 may be powered through a USB connected to a computer. Several 10 expanders may be used to facilitate control using I2C.

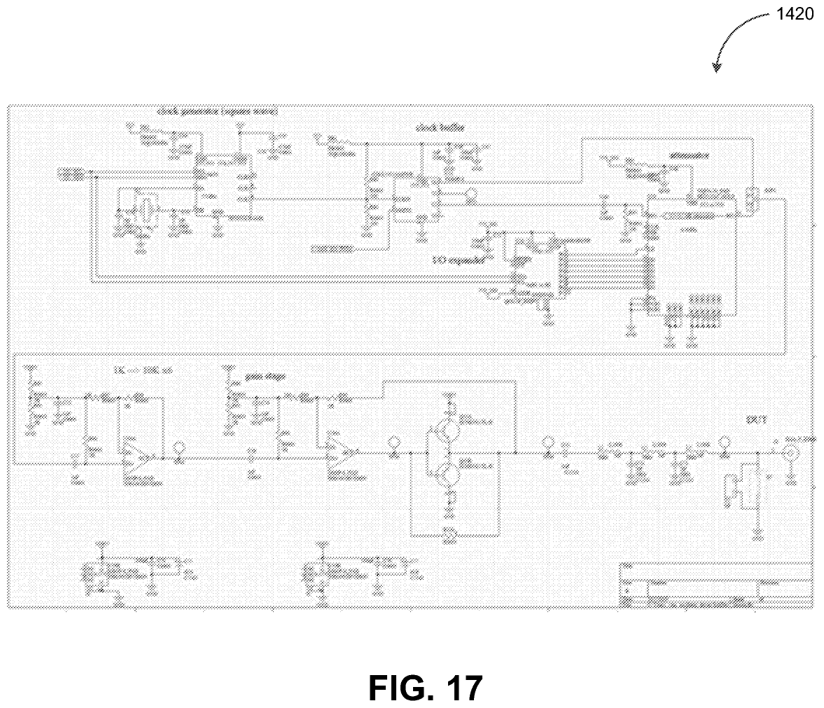

FIG. 17 depicts a circuit diagram illustrating an example of the surface acoustic wave driver 1420, in accordance with some example embodiments. In some example embodiments, the surface acoustic wave driver 1420 may be configured to output high frequency signals ranging from 2.5 KHz to 200 MHz, which may be generated using a CMOS clock IC (Si5351). The surface acoustic wave driver 1420 may use an external 27 MHz Crystal oscillator and a DC supply of 3.3V. This high frequency surface acoustic wave (SAW) signal may be fed to a clock buffer (CDCLVC11) with 4 outputs and the square wave modulation (PWM) signal coming from the microcontroller 1440 may be applied at the enable signal of this buffer. An attenuator is used to control the power of this surface acoustic wave signal. The attenuation ranging from 0.5 to 31.5 dB may be adjusted using 6-bit digital input and it has a 5V supply. Finally, this surface acoustic wave signal may be fed through two stage amplifier using op-amps with supply “VDRV” ranging from 12V-37V. A matching network may also laid out before the SMA connector for tuning, if necessary.

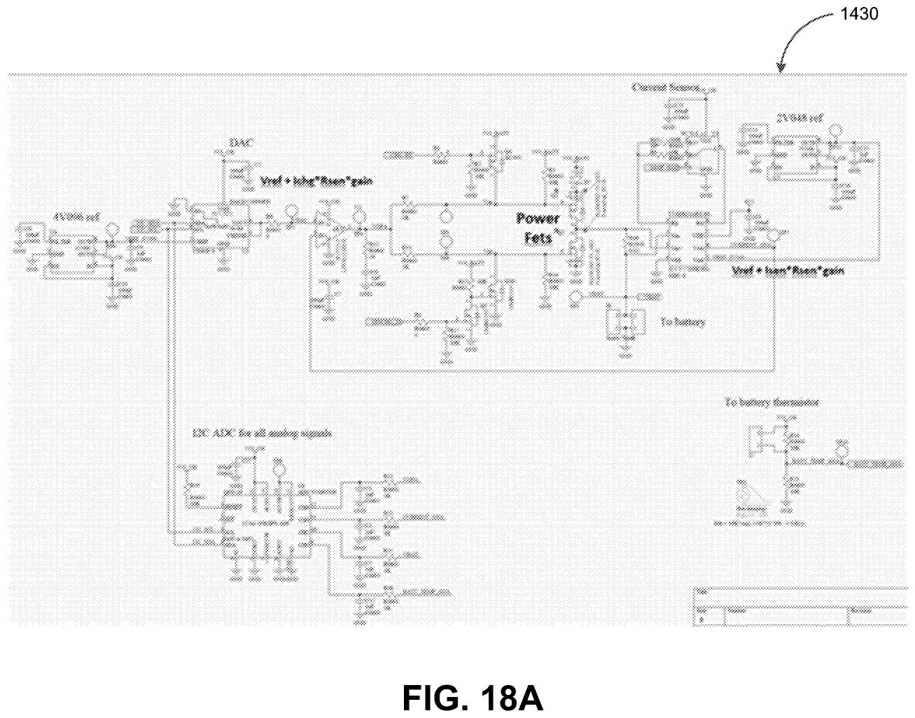

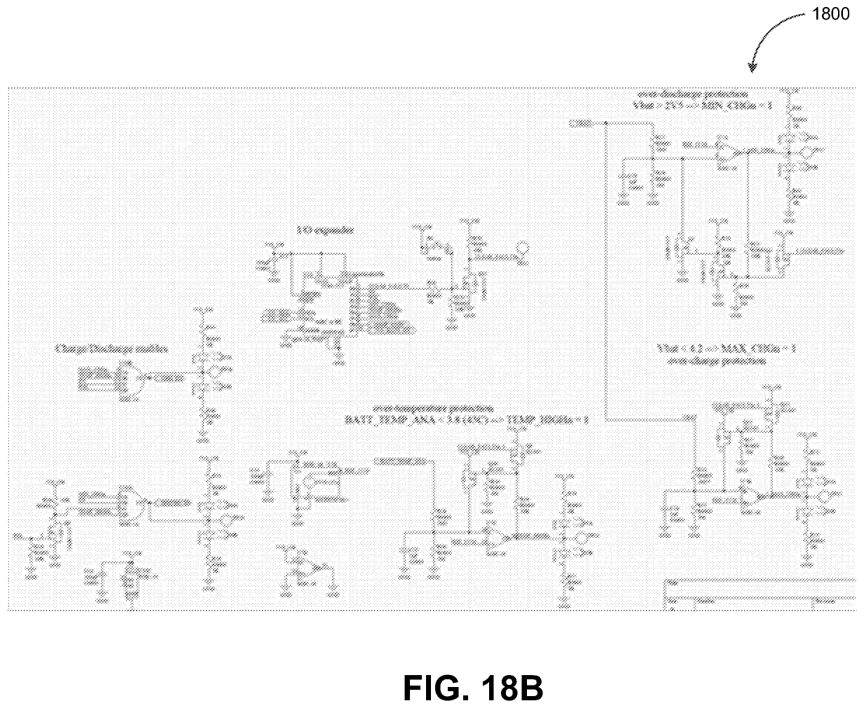

FIG. 18A depicts a circuit diagram illustrating an example of the battery cycler 1430, in accordance with some example embodiments. In some example embodiments, the battery cycler 1430 may use two power FETs (Q1,2), p-channel for charging and n-channel for discharging. These power FETs may have maximum rated drain current of 32A and operate with a 5V supply. To enable the charge or discharge function, switching transistors (Q4,5,16) may be used as shown in FIG. 18A. The main function of the battery cycler 1430 may be to generate a user defined constant current for charging/discharging, which can be achieved using a feedback control. The power FET drain current (Isen) may be sensed using an instrumentation amplifier (AD623). The output of this amplifier (Vref+Isen*Rsen*gain) may be fed back to the non-inverting side of an op-amp. On the inverting side a DAC generated voltage of (Vref+Ichg*Rsen*gain) may be applied, where Ichg is the required current. This feedback loop may adjust Isen to match the Ichg. An ADC (ADS7924) may be used to read out one or more required values such as battery voltage, battery current, temperature, and/or the like.

FIG. 18B depicts a circuit diagram illustrating an example of a battery cycler control circuit 1800, in accordance with some example embodiments. Referring to FIGS. 18A-B, the battery cycler 1830 may include the control circuit 1800 configured to hard-set fault conditions such as, for example, over-discharge, over-charge, over-temperature, and/or the like. When the battery voltage reaches 4.2V, MAX_CHGn may to high to prevent further charging. Likewise, when battery voltage reaches 2.5V, MIN_CHGn may go high to prevent further discharging. If the thermistor attached to the battery 1410 reads 45C, the TEMP_HIGHn goes high to prevent further charging and/or discharging. External push button may be used to clear the fault conditions (e.g., CLEAR_FAULTSn) if these fault conditions are wrongly indicated.

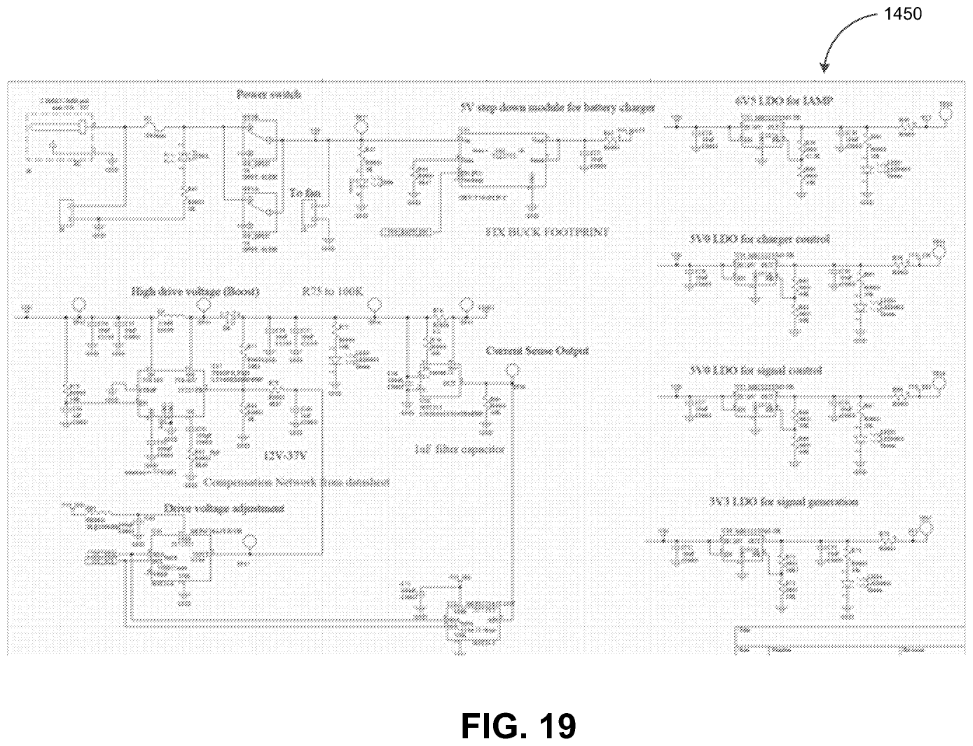

FIG. 19 depicts a circuit diagram illustrating an example of the power management circuit 1450, in accordance with some example embodiments. Different DC supply voltages may used by different components throughout the circuit. All of these supply voltages may be generated on-board from the 12 VDC input. A step-down (12V to 5V) buck converter may be used to obtain the “5V0 _BATT” supply for the FETs in the battery cycler 1430. The “VDRV” voltage may be generated using a controllable boost converter to achieve a voltage of 12V-37V. The remainder voltages (e.g., 5V0_CH,5V0_SIG, 6.5V, 3.3V, and/or the like) may be generated using an LDO since these voltages do not require a large current.

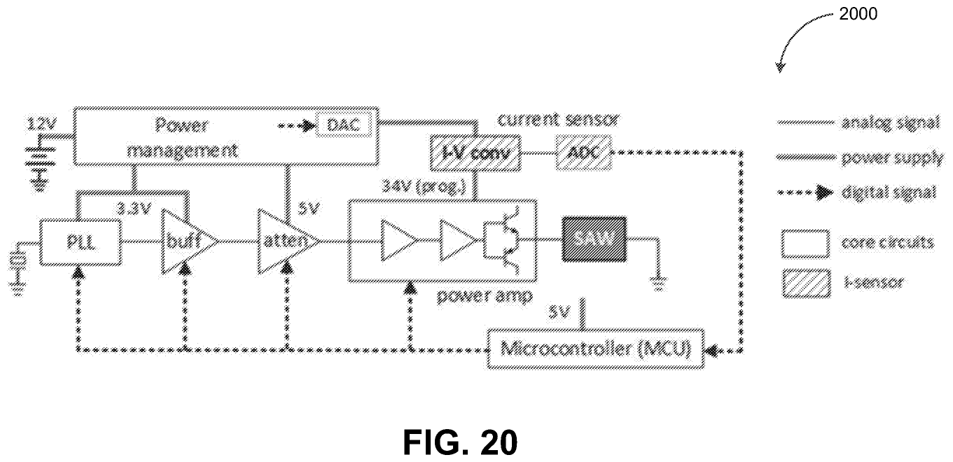

FIG. 20 depicts a block diagram illustrating an example of an electrical driver system 2000 for a surface acoustic wave device, in accordance with some example embodiments. Referring to FIG. 20, despite the differences in the required stimulus frequencies and power levels, the electrical driver system for various surface acoustic wave devices may include a blocks for stimulus generation, amplification, power management, control and user interface, and sensing and feedback.

In some example embodiments, stimulus generation may be accomplished by a class of semiconductor circuits known as “phase locked loops” (PLL), or“frequency synthesizers”. This low-cost solution uses a reference crystal oscillator to produce a highly accurate and stable tone. The frequency is programmable over a specified range with very fine (<0.01 MHz) resolution. However, unlike the benchtop RF signal generators or arbitrary waveform generators (AWG) it replaces, the output amplitude of a phase locked loop is usually fixed. Moreover, phase locked loops may be unable to produce the output power required to drive an acoustic surface wave device, thus requiring an amplification block.

In some example embodiments, a chain of amplifiers may be used to couple the output of the phase locked loop to the input of the surface acoustic wave device, achieving increasingly higher voltage swings (with higher supplies or power consumption) as needed. Furthermore, duty cycle control may be added using the enable signals of clock buffers, attenuators (using dedicated chips or a simple resistor voltage divider) may be used to fine-tune the signal swing, and a power amplifier with a push-pull output stage may be employed to efficiently deliver high current (power) to the surface acoustic wave device. The surface acoustic wave device itself may be modelled as a load of low impedance at the resonance frequency.

In some example embodiments, the power management unit (PMU) may generate, from a single battery or a wall outlet, all of the voltage supplies (such as3.3V, 5V, 24V etc.) required by the various semiconductor chips on the printed circuit board. These circuits are commonly known as “DC-DC converters”. “Boost converters” may be used to step-up voltages from input to output while “low dropout” (LDO) regulators may be used to step-down voltages. If higher efficiency is required, a step-down function may also be achieved using “buck converters”. This unit may replace benchtop power supplies.

In some example embodiments, the micro-controller unit (MCU),such as an Arduino Nano, may serve as the interface between the electronic driver system and the end users. Through general-purpose I2C IO expanders, the microcontroller may translate user inputs and send low-level digital signals to control all components on the printed circuit board (PCB). The microcontroller may be connected through a USB connection to a laptop for maximum programming and testing flexibility. It may also be pre-programmed with a few options (e.g., power on/off, frequency up/down, and/or the like) selected by push-buttons. Accordingly, the resulting surface acoustic wave battery system may be turned into a completely self-contained and user-friendly device.

While the electronics described above may be sufficient to drive the surface acoustic wave device, additional value-added features are still possible. For example, in some example embodiments, the electrical driver system 2000 may include thermistors to monitor temperature on certain sections of the board. Digitized and read by the microcontroller, the measured data may be used to monitor operating conditions or within a feedback loop, for example, to automatically shut down when a given component overheats. The electrical driver system 2000 may also incorporate current sensors on the surface acoustic wave device itself to automatically detect the optimal resonance frequency to combat inevitable device-to-device variations and to account for variations in boundary conditions, particularly when liquid ay be present on the surface of the surface acoustic wave device. These factors may often shift the resonance frequency by 100 kHz or more, which may be enough to significantly reduce the performance of an acoustic transducer with a high Q factor.

For example, the phase locked loop frequency range may be swept by the microcontroller and the output current to the surface acoustic wave device may be measured, digitized, and recorded for each stimulus frequency. A range may be specified in the algorithm to minimize time needed to perform the sweep as well as to allow for the selection of higher harmonics, which can be useful in transducers. The voltage amplitude, V, at the final stage of the signal chain, the driver amplifier, may be constant by virtue of its resistor feedback architecture. As such, the higher the output current amplitude, I, the higher the power, P, delivered to the surface acoustic wave device (e.g., P=VI). The frequency at which the measured current amplitude is maximized may thus correspond to the resonance frequency of the transducer.

In some example embodiments, two-dimensional computations may be performed to support the analysis of various battery cells, in particular to determine the changes in the concentration gradient in a lithium metal battery with and without acoustic streaming as shown in FIG. 1. For the lithium metal battery without the integrated surface acoustic wave device, the electrochemistry module was used with a physics-controlled mesh, tertiary current distribution, and the Nernst-Planck interface. This interface describes the current and potential distribution in an electrochemical cell, taking into account the individual transport of charged species (ions) and uncharged species in the electrolyte due to diffusion, migration and convection using the Nernst-Planck equation below,

$$\frac{\partial {c}_{i}}{\partial \text{?}} + ∇ \cdot {N}_{i} = {R}_{i} , \qquad ( 6 )$$

$$\text{?} \text{indicates text missing or illegible when filed}$$

wherein Nᵢ may denote the flux of charged species in the electrolyte and can be expressed as Nᵢ=−Dᵢ∇Cᵢ−zᵢUₘF_{ci}∇+V□Cᵢu, Cᵢ may denote the concentration of ions i, zᵢ may denote the charge transfer number, Di may denote the diffusion coefficient, Uₘ may denote mobility, F is the Faraday constant, V is the battery potential, and u is the velocity vector.

For the lithium metal battery having the integrated surface acoustic wave deivice, the simulation is more complex, necessitating the sequential use of the pressure acoustic, creeping flow, and electrochemistry modules for frequency and time-domain computations. The volume-force terms (Fᵢ) may be obtained first from the attenuating acoustic wave propagating through the electrolyte via the pressure acoustic module, where

$${F}_{i} = - {\partial }_{i} < L > + \frac{{f}^{2} v b}{c} \text{?} < {\prod }_{i} > where v = \frac{μ}{ρ σ} \qquad ( 7 )$$

$$\text{?} \text{indicates text missing or illegible when filed}$$

and ∂ᵢ<L> refers to the gradient of the potential energy of the wave in a linear medium.

The wave attenuation in COMSOL may be modeled with respect to the wave's power (P) as

$$P ( x ) = {e}^{- i k x} = e \text{?} \qquad ( 8 )$$

$$\text{?} \text{indicates text missing or illegible when filed}$$

where u₀ is the particle displacement, α is the attenuation coefficient, and f is the operating frequency of the surface acoustic wave device.

The volume forces, Fᵢ, found from this calculation may be used in the creeping flow module, represented by a time-average derived expression from mass and momentum conservation to the second order,

−∂ᵢp̅+μ∂ⱼⱼ²v̅ᵢ̅+Fᵢ=0, (9)

providing the acoustic streaming-driven flow field for the electrolyte. This flow field is then used in the electrochemistry module to determine the ion concentration gradient in the electrolyte. The analysis may be useful for a qualitative assessment of the observed phenomena better explored by experiment and theory due to the computational cost of such multiphysics high-frequency phenomena.

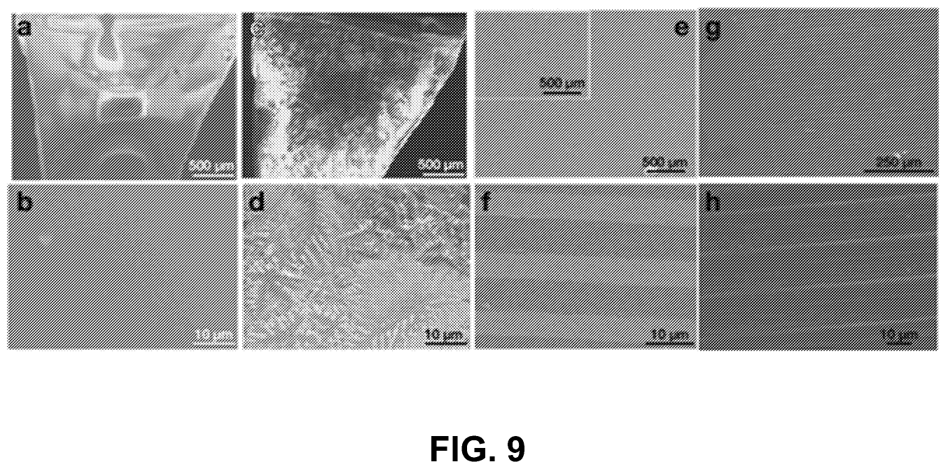

In some example embodiments, to prevent corrosion from the electrolyte present in the lithium metal battery cell, the surface acoustic wave device may be protected using a thin, electrochemically compatible, durable, and acoustically-compatible material. FIG. 9 depicts scanning electron microscope (SEM) images illustrating the condition of a lithium niobate (LN) substrate immersed in an carbonate-based electrolyte (e.g., EC/DEC and/or the like). The pristine morphology of the optically polished lithium niobate surface shown in FIGS. 9(a)-(b) may be corroded, as shown in FIGS. 9(c)-(d) after being immersed in the electrolyte for seven days, with 100-μm long fractal tree-like structures across the surface. As such, the surface of the surface acoustic wave device may be coated in a protective material, such as a film of parylene, in order to prevent corrosion caused by reaction with the electrolyte.

Table 1 below depicts the effects of the parylene film on the performance of the surface acoustic wave device. As shown, the effect of a 200 nm parylene coating may be weak, with a 2% decrease in the displacement, velocity, and acceleration. The parylene film is therefore able to protect the surface acoustic wave device in a harsh environment while imposing a negligible effect (e.g., <1%) on the performance of the surface acoustic wave device.

TABLE 1
Table 1: Performance of the SAW devices at different stages:

| | Uncoated | Parylene | After 280 cycles |
|---|---|---|---|
| | SAW | coated SAW | in electrolyte |
| Displacement (pm) | 4.826 | 4.762 | 4.714 |
| Velocity (mm/s) | 4.069 | 4.01 | 3.97 |
| Acceleration (Mm/s²) | 1.952 | 1.931 | 1.92 |

FIGS. 9(e) and (f) depict the longer-term effects of a carbonate-based electrolyte (e.g., ED/DEC) on a parlyene-coated surface acoustic wave device that has been immersed in the electrolyte for two months. As shown, the surface morphology of lithium niobate substrate and the aluminum interdigital transducer remains pristine. FIGS. 9(g) and (h) depict the morphology of the parlyene coated surface acoustic wave device after 280 cycles. As shown, the parylene coating remains stable on the surface of the surface acoustic wave device even after the long term cycling.

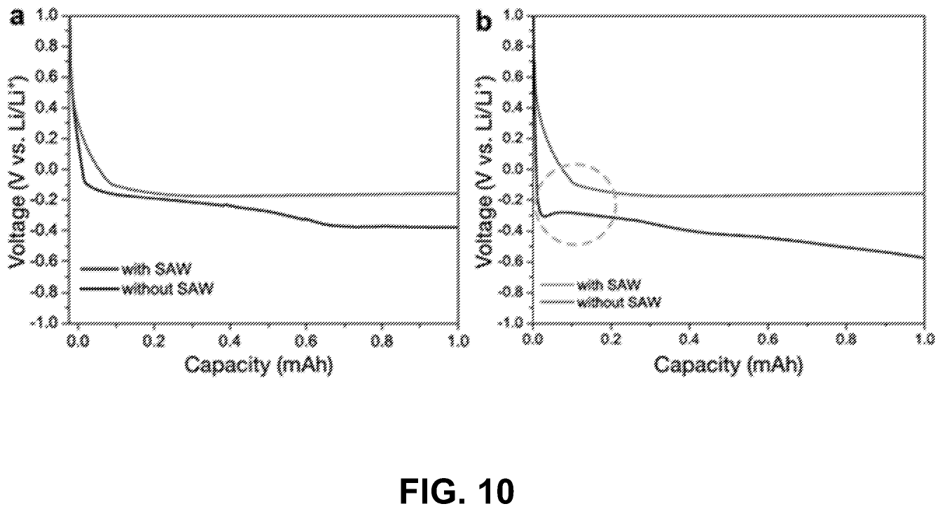

FIG. 10 depicts a comparison of the first cycle deposition performance of a lithium copper battery with and without the presence of surface acoustic waves, in accordance with some example embodiments. The lithium copper batteries show in FIG. 10 may be charged to an capacity of 1 mAh at a current density of 1 mA/cm² and 6 mA/cm². FIG. 10(a) depicts a comparison of the electrodeposition curves at a current density of 1 mA/cm² with (green) and without (black) the presence of surface acoustic waves. Meanwhile, FIG. 10(b) depicts a comparison of the electrodeposition curves at a 6 mA/cm² current density with (green) and without (black) surface acoustic waves.

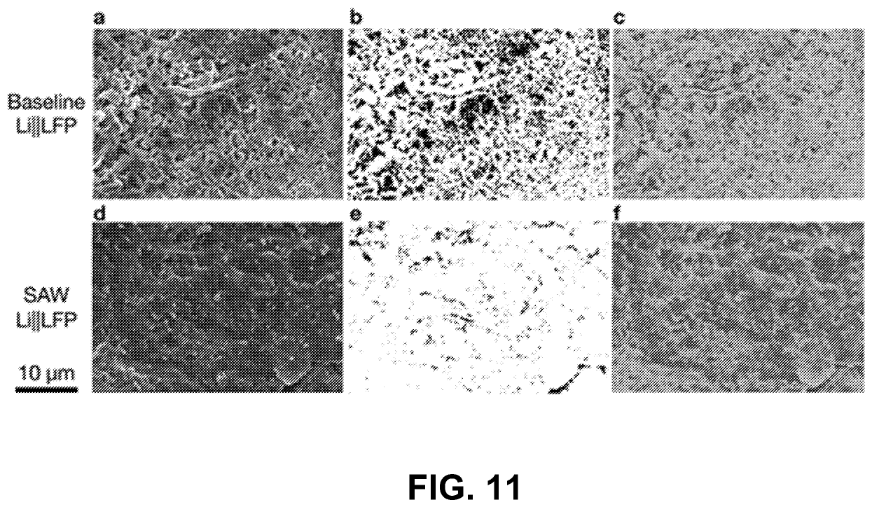

FIG. 11 depicts scanning electron microscope (SEM) images illustrating the operations to obtain lithium electrode porosity, in accordance with some example embodiments. The porosity may be determined for the electrode of the baseline battery (e.g., without an integrated surface acoustic wave device) shown in FIGS. 11(a)-(c) as well as the batteries having the integrated surface acoustic wave device shown in FIGS. 11(d)-(f). For each type of battery, FIGS. 11(a) and (c) may depict a top-down scanning electron microscope image of the lithium electrode, which when thresholded into the binary images shown in FIGS. 11(b) and (d), provides the depth image suitable for determining the porosity shown in FIGS. 11(c) and (e).

In some example embodiments, to overcome the difficulties associated with observing electrolyte acoustic streaming flow induced by surface acoustic waves, a “dummy” battery assembly made of transparent acrylic plates with water couple with polystyrene particles to emulate the conditions of the actual battery in an observable fashion for a set of simple experiments devised to partially validate the COMSOL computations and the analysis results—in particular, the induced fluid flow—may be employed.

Because acoustic streaming is predicated upon the existence of viscosity and compressibility in fluid flow, the typical assumptions of incompressible Stokesian flow at small scales or batteries may be inappropriate. Instead, the full Navier-Stokes representation in conservation of momentum is used. Through knowledge of the amplitude distribution of the surface acoustic wave source in the representative setup using laser Doppler vibrometry, a velocity boundary condition at the electrolyte boundary adjacent the surface acoustic wave device may be defined.

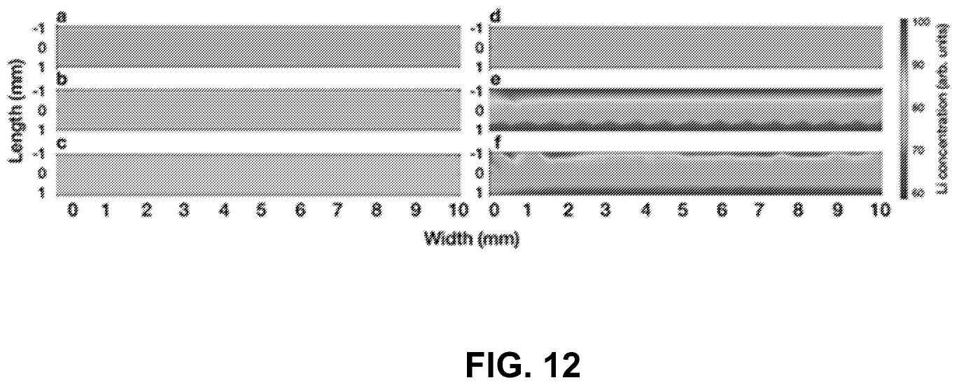

Within the fluid domain, the convection-diffusion equation with the lithium ion (Li⁺) species present in the electrolyte under the action of insertion upon the anode and extraction from the cathode according to the configuration dimensions of the prototype battery and the charge rates of 6 mAcm⁻² (equivalent to 6 C) may be included. As shown in FIG. 12, although the analysis lacks any initial “hotpsots” as posited to exist for the analysis, it does nonetheless indicate the benefit of surface acoustic wave driven acoustic streaming flow in reducing the inhomogeneous lithium ion distribution in the interelectrode gap. It is shown that at the beginning of the charge, all the lithium ions are at the anode (as shown in the top layer of the set up) for a baseline battery without surface acoustic waves and a battery having the integrated surface acoustic wave device (e.g., FIGS. 12(a) and (d)).

Referring again to FIG. 12, FIGS. 12(a)-(c) may depict he change in lithium ion concentration at 0%, 50%, and 100% state of charge (SOC) with acoustic streaming. As shown, the concentration gradient may remain homogeneous throughout the charging process. By contrast, the concentration gradient of lithium ions in a baseline battery without surface acoustic waves at 0%, 50% and 100% state of charge are shown in FIGS. 12(d)-(f), respectively. Here, the absence of surface acoustic waves is shown to be associated with a large change in the concentration gradient.

Referring again to Equations (1)-(3), the problem associated with those equations may be rendered dimensionless, and hence simplified, by using the transformations

$$x \to δ x , y \to δ y , c \to {c}_{b u l k} c , ( u , v ) \to {u}_{c} ( u , v ) , L \to δ L , k \to k δ , h \to \frac{h}{δ} .$$

Doing so may give rise to Equations (10)-(12) below.

$$u {\partial }_{x} c + v {\partial }_{y} c = \frac{1}{Pe} ( {\partial }_{xx} c + {\partial }_{yy} c ) , subject to , \qquad ( 10 )$$

$$\frac{1}{A} \int \int , c d A = 1 \qquad ( 11 )$$

$$c = ϵ ( 1 + cos ( k x ) ) at y = 0 , \qquad ( 12 )$$

which introduces two small parameters, e.g., 1/Pe<<1 (Pe=u_{c}δ/D>>1) in Equation (10) and ∈<<1 in Equation (12). Assuming a simple shear flow in the vicinity of the lithium electrode, u=y and v=0.

Equations (10)-(12) may support a transport boundary layer of ions and hence are associated with a singular asymptotic expansion of the concentration c in 1/Pe. There is therefore an outer concentration field far from the lithium electrode, described by C, and an inner (boundary layer) concentration filed near the electrode, described by c. In order to solve the inner (boundary layer) problem, the coordinate y may be rescaled in the form y=YPe⁻ⁿ, so that the leading order diffusive term satisfies convection. Both concentration fields must satisfy that lim_{y→}∞c. The leading order concentration field may be expanded in powers of E according to the series expansion C=C₀+∈C₁+ . . . and c=∈C₁+ . . . .

To leading order, the problem associated with Equations (10)-(12) in the outer field may satisfy the system of equations.

$$u {\partial }_{x} {C}_{0} + v {\partial }_{y} {C}_{0} = 0 , \\ \frac{1}{A} \int {\int }_{A} {C}_{0} dA = 1 ,$$

which gives the trivial solution C₀=1. In the inner (boundary layer) field, where the transformation y+YPe⁻ⁿ is used, the problem takes the leading order form,

Y∂ₓc₀=∂_{YY}C₀.

where n=⅓, so that the leading order diffusive terms is satisfied by convection. The corresponding boundary conditions at the surface of the electrode and far away from the boundary layer (where the inner solution is matched to the outer solution) are then,

c₀=0 at Y=0, and c₀=1 at Y→∞.

respectively. An analytical similarity to this problem is obtained by using the transformation

$$ζ ≡ \frac{Y}{{x}^{\frac{1}{3}}} .$$

The boundary layer problem then translates to

$$- \frac{{ζ}^{2}}{3} \frac{d {c}_{0}}{d ζ} = \frac{{d}^{2} {c}_{0}}{d {ζ}^{2}} , and {c}_{0} = 0 at ζ = 0 , {c}_{0} = 1 at ζ \to ∞ .$$

This system of equations is satisfied by

$${c}_{0} = \frac{{3}^{1 / 3}}{Γ ( 1 / 3 )} \int \text{?} {e}^{-} \text{?} d \text{?} \qquad ( 13 )$$

$$\text{?} \text{indicates text missing or illegible when filed}$$

where Γ( ) is the Euler gamma function and Γ(⅓)≈2.68.

Taking the y derivative of the leading order concentration near the surface of the lithium electrode at Y=ζ=0, gives,

$${\partial }_{y} {c}_{0} {\vert}_{y = 0} = \frac{d {c}_{0}}{d ζ} \times {\partial }_{y} ζ {\vert}_{y - ζ = 0} = \frac{{3}^{1 / 3}}{Γ ( 1 / 3 )} {( \frac{P e}{x} )}^{1 / 3} . \qquad ( 14 )$$

Hence, the dimensional flux of ions to the electrode is,

$${i}_{0} = - D {\partial }_{y} {c}_{0} {\vert}_{y = 0} = - D \frac{{3}^{1 / 3}}{Γ ( 1 / 3 )} \frac{{c}_{bulk}}{δ} {( \frac{P e}{x / δ} )}^{1 / 3} . \qquad ( 15 )$$

where the negative sign infers that the flux is to the electrode. Thus, it is clear that the current generally increases when the Peclet number (the convective flow) increases and when the characteristic length scale of the flow decreases (shear rate increases) while the surface of the electrode is flat and homogeneous. Moreover, the current decreases downstream since the convection of ions reduce the variations in ion concentration along this direction.

Since C₀ is a constant, the next order problem set forth in Equations (10)-(12) in the outer field may satisfy the system of equations

$$u {\partial }_{x} {C}_{1} + v {\partial }_{y} {C}_{1} = 0 , \\ \frac{1}{A} \int {\int }_{A} {C}_{1} d A = 0 ,$$

which gives the trivial solution C₁=0.

The next order problem Equations (10)-(12) in the inner field is

Y∂ₓc₁=∂_{YY}c_{0.} (16)

c₁=1+cos(kx) at Y=0. (17)

c₁=0 at Y→∞. (18)

where the transformation y=YPe^{-1/3} may be used again and further requires that ε≈Pe^{-2/3} in order to include the perturbation of the ion concentration in Equation (17). This problem may be written as a superposition of three subproblems, where c₁=c_{1,1}+c_{1,2}+c_{1,3}. Solving the problem for c_{1,1}, which is given by omitting the forcing term ∂ₓₓc₀ from Equation (16) and replacing Equation (17) by c_{1,1}=1 at Y=0, one obtains that

$${c}_{1 , 1} = - \frac{{3}^{1 / 3}}{Γ ( 1 / 3 )} {\int }^{ζ} \text{?} {e}^{-} \text{?} d \text{?} \qquad ( 19 )$$

$$\text{?} \text{indicates text missing or illegible when filed}$$

Hence, the corresponding dimenstional flux of ions is,

$${i}_{1 , 1} = - D {\partial }_{y} {c}_{1 , 1} \vert \text{?} = - D \frac{{3}^{1 / 3}}{Γ \text{?} 1 / 3 \text{?}} \frac{{c}_{bulk}}{δ} {( \frac{P e}{x / δ} )}^{1 / 3} . \qquad ( 20 )$$

$$\text{?} \text{indicates text missing or illegible when filed}$$

One can further write the problem for c_{1,2} by omitting the forcing term ∂ₓₓc₀ from Equation (16) and replacing Equation (17) by c_{1,2}=cos kx at Y=0. The problem is written as,

Y∂ₓc̅_{1,2}=∂_{YY}c̅_{1,2} (21)

c̅_{1,2}=e^{ikx} at Y=0. (22)

c̅_{1,2}=0 at Y→∞. 923)

using the complex variable c_{1,2} whose real component is c_{1,2}.

Using the transformation c_{1,2}=f(Y)e^{ikx} in (21)-923) gives the alternate system of equations,

$$i k Y f = \frac{{d}^{2}}{{Y}^{2}} , \\ f = 1 at Y = 0 , \\ f = 0 at Y \to ∞ ,$$

which is satisfied by the complex solution

f=3^{2/3}Γ(2/3)Ai((ik)^{1/3}Y). (24)

where Ai is the Airy function of the first kind. The Airy function decays in the limit Y→∞ subject to the argument (ik)^{1/3}.

The real component of the Y derivative of c_{1,2} is given by,

$${\partial }_{Y} {c}_{1 , 2} {\vert}_{Y = 0} = \frac{\sqrt{π} {( 3 / 2 )}^{1 / 3}}{Γ ( 1 / 6 )} {k}^{1 / 3} ( sin ( k x ) - \sqrt{3} cos ( k x ) . \qquad ( 25 )$$

Hence, the corresponding dimensional flux of ions is,

$${i}_{1 , 2} = - D {\partial }_{{c}_{1 , 2} {\vert}_{y = 0}} = - D \frac{\sqrt{π} {( 3 / 2 )}^{1 / 3}}{Γ ( 1 / 6 )} \frac{{c}_{b u l k}}{δ} {( k δ )}^{1 / 3} ( sin ( k x ) - \sqrt{3} cos ( k x ) ) {Pe}^{1 / 3} . \qquad ( 26 )$$

Finally, one can write the problem for c_{1,2} using Equation (16) and replacing Equation (17) by c_{1,3}=0 at Y=0. The problem for c_{1,3} gives a spatially monotonic solution and requires a numerical solution; however, this solution does not contribute to the leading order solution for the dendrite free length of the electrode. Hence, we refer to the solution of this problem in terms of its order of magnitude of O(ε) in the followings.

The total ion flux to the Li electrode is given by i=i₀+ε(i_{1,1}+i_{1,2}+i_{1,3}), which translates to,

$$\frac{- i}{{Pe}^{1 / 3} D {c}_{bulk} / δ} = \frac{{3}^{1 / 3} ( 1 - ϵ )}{Γ ( 1 / 3 )} {( x / δ )}^{- 1 / 3} + ϵ \frac{\sqrt{π} {( 3 / 2 )}^{1 / 3}}{Γ ( 1 / 6 )} {( k δ )}^{1 / 3} ( sin ( k x ) - \sqrt{3} cos ( k x ) ) + O ( ϵ ) , \qquad ( 27 )$$

where again ε≈Pe^{-2/3}. A similar problem and solution may appear in the case where the value of r is arbitrary while satisfying 1>>ε>>Pe^{-2/3}, with the exception that the forcing term ∂ₓₓc₀ does not exist in Equation (16) and hence the result given in Equation (27) does not contain the third term on the right hand side of the equation, given as O(ε).

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A battery, comprising at least:
a first electrode;
a second electrode;
an electrolyte interposed between the first electrode and the second electrode; and
at least one acoustic device configured to generate acoustic streaming during a charging and/or a discharging of the battery, the charging of the battery triggering cations from the first electrode to travel through the electrolyte and deposit on the second electrode, the discharging of the battery triggering cations from the second electrode to travel through the electrolyte and deposit on the first electrode, the acoustic streaming driving a mixing and/or a turbulent flow of the electrolyte, the mixing and/or the turbulent flow of the electrolyte increasing a charge rate and/or a discharge rate of the battery by at least increasing a diffusion rate of cations and/or anions, and the mixing and/or the turbulent flow further preventing a formation of dendrites on the first electrode and/or the second electrode by at least homogenizing a distribution of the cations and/or anions in the electrolyte.

2. The battery of claim 1, wherein the homogenization prevents the formation of dendrites by at least decreasing a concentration gradient of the cations and/or anions in the electrolyte.

3. The battery of claim 1, wherein the homogenization prevents the formation of dendrites by at least increasing a uniformity of the distribution of the cations and anions in the electrolyte.

4. The battery of claim 1, wherein the homogenization prevents the formation of dendrites by at least increasing a uniformity of the deposit of cations on the first electrode and/or the second electrode.

5. The battery of claim 1, wherein the mixing flow of the electrolyte further maximizes a transport of cations and/or anions to replace the cations and/or anions depleted from the electrolyte during the charging and/or the discharging of the battery.

6. The battery of claim 1, wherein the electrolyte comprises one or more of a liquid electrolyte, a polymer-based electrolyte, an organic electrolyte, a solid electrolyte, a non-aqueous organic solvent electrolyte, and a gas electrolyte.

7. (canceled)

8. The battery of claim 1, wherein the first electrode comprises an anode of the battery.

9. The battery of claim 8, wherein the transducer comprises one or more pairs of interdigital transducers, a layer of conductive material, and/or one or more contact pins.

10. The battery of claim 8, wherein the anode of the battery is formed from an intercalated material including at least one of a graphite, graphene, and/or titanium dioxide (TiO2)).

11. The battery of claim 8, wherein the anode of the battery is formed from an alloy including at least one of a silicon (Si), aluminum (Al), and tin (Sn).

12. The battery of claim 8, wherein the anode of the battery is formed from a conversion material including a copper peroxide (CuO₂).

13. The battery of claim 1, wherein the second electrode comprises a cathode of the battery.

14. The battery of claim 13, wherein the cathode of the battery comprises one or more of an intercalation type electrode, a conversion type electrode, an alloy type electrode, or an air electrode.

15. (canceled)

16. (canceled)

17. (canceled)

18. The battery of claim 1, wherein the at least one acoustic device comprises a transducer deposited on a substrate, wherein the transducer is configured to respond to an electrical input signal by at least applying tension and compression within and/or upon the substrate, and wherein the substrate responds to the tension and the compression by at least oscillating to generate a plurality of acoustic waves.

19. The battery of claim 18, wherein the plurality of acoustic waves include surface acoustic waves, Lamb waves, flexural waves, thickness mode vibrations, mixed-mode waves, longitudinal waves, shear mode vibrations, and/or bulk wave vibrations.

20. The battery of claim 18, wherein the at least one acoustic device comprises one or more pairs of interdigital transducers, a layer of conductive material, and/or one or more contact pins.

21. The battery of claim 18, wherein the substrate is formed from at least a piezoelectric material.

22. (canceled)

23. The battery of claim 1, wherein the at least one acoustic device is configured to generate a plurality of acoustic waves having a frequency corresponding to an attenuation length of the plurality of acoustic waves, and wherein the attenuation length corresponds to a first length of the first electrode, a second length of the second electrode, and/or a distance between the first electrode and the second electrode.

24. The battery of claim 1, wherein the at least one acoustic device is integrated inside a case of the battery and/or integrated on the case of the battery.

25. The battery of claim 1, wherein the battery comprises a coin cell, a pouch cell, or a cylindrical cell.

26. The battery of claim 1, wherein the battery is coupled with a circuit configured to drive the at least one acoustic device, and wherein the circuit includes an integrated battery charging circuit and an automatic resonance search function.

27-30. (canceled)
